(19) United States
(12) Patent Application Publication
(10) Pub. No.: US 2024/0390975 A1
(43) Pub. Date: Nov. 28, 2024

(54) HIGH THERMAL CONDUCTIVITY, LOW THERMAL EXPANSION COMPOSITES

(71) Applicant: The Research Foundation for The State University of New York, Binghamton, NY (US)

(72) Inventors: Scott N. Schiffres, Vestal, NY (US); Arad Azizi, Buffalo, NY (US)

(21) Appl. No.: 18/669,761

(22) Filed: May 21, 2024

Related U.S. Application Data
(60) Provisional application No. 63/468,228, filed on May 22, 2023.

(51) Int. Cl. B22F 1/12; B22F 10/28; B33Y 10/00; B33Y 70/00; B33Y 80/00

(52) U.S. Cl. CPC B22F 1/12; B22F 10/28; B22F 2302/10; B22F 2302/406; B33Y 10/00; B33Y 70/00; B33Y 80/00

(57) ABSTRACT

Additively manufactured non-metal particle and metal matrix composites are provided. An intermetallic compound interface layer, e.g., metal carbide, is formed between the non-metal particle, e.g., diamond, and the metal matrix, that enhances thermal transfer. One application of this is to form thermal management structures with high thermal conductivity via laser powder bed fusion. A powder material for additively manufacturing a structure, comprising metal particles; and non-metallic particles with thermal conductivities greater than 100 W/m-K and coefficient of thermal expansion less than 10 ppm/degree C., wherein the metal particles are fusible with heat to form a heterogeneous solid structure around the non-metallic particles with an intermetallic compound interface, the heterogeneous solid structure having enhanced thermal conductivity and lower coefficient of thermal expansion with respect to a homogeneous specimen of the fused metal particles alone.

### CROSS REFERENCE TO RELATED APPLICATIONS

The present application is a non-provisional of, and claims benefit of priority under 35 U.S.C. § 119(e) from, U.S. Provisional Patent Application No. 63/468,228, filed May 22, 2023, the entirety of which is expressly incorporated herein by reference.

### FIELD OF THE INVENTION

The present invention relates to the field of additive manufacturing of diamond-metal matrices, graphitic-metal composites, and boron nitride-metal composites, more particularly to additive manufacturing of high thermal conductivity composites, resulting in a fabricated product comprising diamond, graphitic material (CNT, graphene), or BN-based compounds within a metal matrix.

### BACKGROUND OF THE INVENTION

### Incorporation by Reference and Interpretation of Language

Citation or identification of any reference herein, in any section of this application, shall not be construed as an admission that such reference is necessarily available as prior art. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The incorporation by reference does not extend to teachings which are inconsistent with the invention as expressly described herein (which may be treated as counter examples), and is evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the express specification, incorporated references cited for propositions, incorporated references in general, the inventors' prior publications relating to the field, academic literature in the field, commercial literature in the field, field-specific dictionaries, lay literature in the field, general purpose dictionaries, and common understanding.

The claims are to be interpreted as encompassing tangible expressions, and should not be interpreted as encompassing abstract ideas not integrated into practical application.

Current microprocessors are reaching heat fluxes of 1 W/mm² {11}, and power electronics (e.g., GaN high-electron-mobility transistors [HEMTs]) have local “near-junction” heat fluxes approaching 10 kW/mm², greater than the sun's surface, and average heat fluxes of 100 W/mm² {12-16}. The heat generated by the microprocessor transistors must travel through the thickness of the substrate, a thermal interface material (TIM) (often referred to as a die-attach material by industry), a heat-spreader/lid, a second TIM, and finally to a heat removal device (e.g., heat pipe wick or heat exchanger) {17}. Heat generated in a GaN HEMT must travel through the substrate, a die-attach material, and into a heat exchanger.

Wicks are porous materials that draw liquid through capillary action to facilitate evaporative cooling in two-phase devices, such as heat sinks. The thermal conductivity of the wick material is very important, as it will limit the heat transfer into the fluid {19-40}. Similarly, additively manufactured micro channels need to be made of high thermal conductivity materials because the microchannel walls act as fins whose efficiency is a function of their thermal conductivity {41-48}. Moreover, the versatility of additively manufactured (“printed”) heat sinks will enable geometries to fit each application (more cooling to local hot spots on device) {49-51}. By additively manufacturing the wicks and cooling channels, the thermal resistance can be reduced or otherwise optimized to minimize energy consumption and increase device reliability.

Laser powder bed fusion (L-PBF) is the most common method of additively manufacturing metal parts. This process works by using a focused laser beam (Ø˜75 μm) to locally melt a metal powder into a solid part, layer-by-layer. The laser is rastered via galvonometer-steered mirrors and focused with an f-theta lens or dynamic focusing. After a single layer of powder is fused into the part, a recoater blade deposits a layer of powder on top of the part (20-100 μm typical), and the process repeats. The process chamber is filled with an inert gas (N₂ or Ar) to prevent oxidation. Conventionally, metal additively manufactured parts are built on a build platform made of the same material to facilitate strong mechanical bonding. Direct dissimilar bonding of semiconductor substrates to metals via additive manufacturing has been discussed in the literature in previous studies {3,18}.

There has been little work on laser powder bed fusion of metal diamond composites and this prior work has been predominantly focused on mechanical properties, especially for grinding tools {52-54}. One prior are reference did measure the thermal conductivity of a printed copper-diamond composite and found it its thermal conductivity less than bulk copper (˜350 W/m-K for the copper-diamond composite versus ˜400 W/m-K (at 0° C.) for pure copper) {52}. Silver has a thermal conductivity of ˜429 W/m-K (at 0° C.). In particular, this prior work functionalized the diamond with films of TiC and then TiO₂ (approximately 0.7 μm thick films) to improve wetting; however such a thick oxide coating posed a considerable thermal resistance {52}.

Diamond is the allotrope of carbon in which the carbon atoms are arranged in the specific type of cubic lattice called diamond cubic. Diamond is the hardest naturally occurring material known. Most diamonds are electrical insulators and extremely efficient thermal conductors. Diamond is extremely strong owing to its crystal structure, known as diamond cubic, in which each carbon atom has four neighbors covalently bonded to it.

Unlike most electrical insulators, diamond is a good conductor of heat because of the strong covalent bonding and low phonon scattering. Thermal conductivity of natural diamond was measured to be about 2200 W/(m·K), which is five times more than silver, the most thermally conductive metal. Monocrystalline synthetic diamond enriched to 99.9% of the isotope ¹²C had the highest thermal conductivity of any known solid at room temperature, 3320 W/(m·K), though reports exist of superior thermal conductivity in both carbon nanotubes and graphene. Because diamond has such high thermal conductance it is already used in semiconductor manufacture to prevent silicon and other semiconducting materials from overheating. At lower temperatures conductivity becomes even better, and reaches 41000 W/(m·K) at 104 K (¹²C-enriched diamond).

Anthony, T. R.; Banholzer, W. F.; Fleischer, J. F.; Wei, Lanhua; et al. (1990). “Thermal conductivity of isotopically enriched 12C diamond”. Physical Review B. 42 (2): 1104-1111. Bibcode:1990PhRvB.42.1104A. doi:10.1103/PhysRevB.42.1104. PMID 9995514.

Wei, Lanhua; Kuo, P. K.; Thomas, R. L.; Anthony, T. R.; Banholzer, W. F. (1993). “Thermal conductivity of isotopically modified single crystal diamond”. Physical Review Letters. 70 (24): 3764-3767. Bibcode:1993PhRvL.70.3764 W. doi:10.1103/PhysRevLett.70.3764. PMID 10053956.

Technologically, the high thermal conductivity of diamond is used for the efficient heat removal in high-end power electronics. Diamond is especially appealing in situations where electrical conductivity of the heat sinking material cannot be tolerated e.g., for the thermal management of high-power radio-frequency (RF) microcoils that are used to produce strong and local RF fields.

Diamond carries heat predominantly through quantized lattice vibrations called phonons. The characteristic phonon frequencies in the diamond are at higher frequencies than phonons in high thermal conductivity metals like copper and aluminum {55}. This means these traditional heat sink metal materials have poor phononic vibrational overlap in their density of states with diamond, so they will have poorer phonon transport into the diamond, in the manner of an impedance mismatch. Carbides have higher characteristic phonon frequency owing to their stiffer elastic moduli than metals {9,56-60}. This higher elastic moduli stems from the long-range order and the greater energy stored in the bonds, as evidenced by being enthalpically favored over solid solutions of metal and carbon. The Debye temperature (T_{D}), from the Debye approximation to the phonon dispersion, is the temperature at which nearly all the phonon modes are active, and the specific heat approaches the 3Nk_{b} limit, where N is the number of molecules and k_{b} is the Boltzmann constant. The Debye temperature can be related to a Debye frequency (ω_{d}=2πk_{b}T_{D}/h), which is the maximum frequency for thermal energy storage according to the simplified Debye model, where h is Planck's constants {61-63}. The higher the Debye temperature, the higher the characteristic vibrational frequency {61}. The diffuse mismatch model suggests that materials with closer Debye temperatures will have higher interfacial thermal conductances.

Consider an interface of diamond, which has T_{D} of 2360 K, with pure Cu, pure Ti, or a metal carbide compound (FIGS. 1A and 1B). Stoichiometric carbide compounds have significantly higher Debye temperatures {64} and therefore, predictably higher conductance, as calculated with the diffuse mismatch model. Note by comparison, common solder metals have Debye temperatures less than 200 K, indicating a much lower phonon vibrational spectrum and poor phonon overlap with diamond and semiconductors {65-70}. The diffuse mismatch calculation predicts that metal-carbide stoichiometric compounds will have a conductance 14 times higher than the conductance of pure Cu at room temperature {69}; hence, additively manufactured diamond metal composites with metal carbide interfaces show promise in reducing electronic operating temperatures.

FIG. 1B shows effective conductivity vs volume fraction for different thermal boundary conductances using the model of Hasselman and Johnson {71}. The upper curves are representative of the good thermal boundary conductance expected between TiC and diamond, versus the lower curve being representative of a poor thermal boundary conductance for a non-carbide metal diamond interface. The thermal boundary conductance makes a dramatic different.

Low-temperature bonding metal alloys can be printed onto semiconductor or ceramic substrates using active elements such as Ti, Zr, V, Nv, Hf, Ta, Mo, Cr, and W. The active alloy may form intermetallic compounds such as silicides on Si and SiC, and carbides on graphite, and diamond, or amorphized mixtures of the substrate and reactive metal elements on the surface of many dissimilar substrates. After printing of the low-melt alloy, the powder material to be sintered can be switched to high conductivity metals such Al, Cu, and their alloys to form high conductivity structures onto the low-melt interlayer alloy.

While diamond has the highest thermal conductivity, other carbon compounds like diamond, graphene, graphite (pyrolytic), also have high thermal conductivity and low thermal expansion. Likewise, boron-nitride compounds also have high thermal conductivity and low coefficient of thermal expansion.

S. N. Schiffres, A. Azizi, Additive manufacturing processes and additively manufactured products, U.S. Ser. No. 11/167,375B2, 2021. patents.google.com/patent/U.S. Ser. No. 11/167,375B2/en (accessed Dec. 10, 2021).

S. N. Schiffres, A. Azizi, Additive manufacturing processes and additively manufactured products, US20200047288A1, 2020.

Thermal stresses in laser or electron based additive manufacturing processes such as selective laser melting, and electron beam melting is an important consideration.

P. Mercelis, J. Kruth, Residual stresses in selective laser sintering and selective laser melting, Rapid Prototyping Journal. 12 (2006) 254-265. doi.org/10.1108/13552540610707013.

J. P. Kruth, L. Froyen, J. Van Vaerenbergh, P. Mercelis, M. Rombouts, B. Lauwers, Selective laser melting of iron-based powder, Journal of Materials Processing Technology. 149 (2004) 616-622. doi.org/10.1016/j.jmatprotec.2003.11.051.

In powder bed fusion systems, a thin layer of powder (usually metal) is deposited onto a similar or dissimilar substrate by a recoating or deposition mechanism. The laser or electron beam which is redirected by the optics in the printer is focused on the focal plane which is the powder on the substrate or the slice of solid part that is being built. The laser or electron beam melts and fuses the powder to the substrate or the prior slice of the solid part. The laser or electron beam moves across the focal plane by a beam steering mechanism, such as galvo mirror system, to create a geometry or pattern at that specific to each slice of the build.

Yao, U.S. 2015/0286757 provides a method for efficiently predicting the quality of additively manufactured metal products. The method numerically models the Direct Metal Additive Manufacturing process with the layer-by-layer building of the metal products, separating the global macro-scale modeling and the local micro-scale modeling, with a database to link in between. The database containing the micro-scale modeling results can be established well before the global scale product simulation is conducted, and therefore the global modeling and database may be used to simulate the additive manufacturing of the whole product, without using the time-consuming micro-scale modeling simultaneously.

Direct Metal Additive Manufacturing (DMAM) applies the metal powder by spreading a layer or spraying directly on solids, and applies a point heat source of laser or electron-beam at selected locations to melt the powder onto the partially made products. Then, another layer of metal is added on top of this layer. The significant challenges of product qualities are the distortions or fracturing as well as the undesirable micro-structures of the products, arising from significant residual stress and uncontrolled phase transformation during freezing and cooling.

When the point heat source applied to the powder or solid surface a molten metal pool is formed. The local freezing process of the melt pool could determine the local crystalline structure of the material. When the molten pool starts to freeze there is no stress, but the surrounding metal is at a temperature much below the molten temperature of the freezing pool.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More specifically, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Electron beam melting (EBM) utilizes a focused electron beam to melt powder. These processes involve melting layers of powder successively to build an object in a metal powder.

AM techniques may be characterized by using a laser or an energy source to generate heat in the powder to at least partially melt the material. Accordingly, high concentrations of heat are generated in the fine powder over a short period of time. The high temperature gradients within the powder during buildup of the component may have a significant impact on the microstructure of the completed component. Rapid heating and solidification may cause high thermal stress and cause localized non-equilibrium phases throughout the solidified material. Further, since the orientation of the grains in a completed AM component may be controlled by the direction of heat conduction in the material, the scanning strategy of the laser in an AM apparatus and technique becomes an important method of controlling microstructure of the AM built component. Controlling the scanning strategy in an AM apparatus is further crucial for developing a component free of material defects, examples of defects may include lack of fusion porosity and/or boiling porosity. A laser and/or energy source is generally controlled to form a series of solidification lines in a layer of powder based on a pattern. A pattern may be selected to decrease build time, to improve or control the material properties of the solidified material, to reduce stresses in the completed material, and/or to reduce wear on the laser, and/or galvanometer scanner and/or electron-beam. Various scanning strategies have been contemplated in the past, and include, for example, chessboard patters and/or stripe patterns.

One challenge associated with laser-based AM is producing a desired melt pattern in the powder while maintaining a desired speed of the build process. The buildup of heat within the powder and fused material during a build is a concern, as various material defects may occur if too much heat is built up in the material during an AM process and/or if insufficient heat is built up to properly fuse the powder. Since variance of the scan pattern in each build layer is generally desirable during an AM build, a waveform shaped scan pattern is used to create variance in the AM build layers, and by controlling the speed of the laser, the laser power, and the period, frequency, and amplitude of the waveform scan pattern, desirable material properties and efficiency of the build is achieved.

Sn₃Ag₄Ti, a low melt alloy, bonds to silicon via titanium silicide formation at the interface during selective laser melting {1,2,15}. Deposition of this material onto silicon chip over a large coverage area with common scanning patterns such as alternating lines damages the chip/electronic package. The damage can be in the form of microscopic internal cracks in the silicon, damage to the transistors or breaking of the electrical connections such as interconnects between the silicon and the electronic substrate. This damage is due to coefficient of thermal expansion mismatch between silicon and Sn₃Ag4Ti and localized heat buildup. This example shows how segmentation scanning strategy can be implemented to avoid such damage and minimize thermal stresses during the print process. See, U.S. Pat. No. 11,167,375, US 2020/0047288, A. Azizi, M. A. Daeumer, S. N. Schiffres, Additive laser metal deposition onto silicon, Additive Manufacturing. 25 (2019) 390-398. doi.org/10.1016/j.addma.2018.09.027.

Additive manufacturing is well known. See the following U.S. patents and published patent applications listed in the below references.

An intermetallic (also called an intermetallic compound, intermetallic alloy, ordered intermetallic alloy, and a long-range-ordered alloy) is a type of metallic alloy that forms a solid-state compound exhibiting defined stoichiometry and ordered crystal structure. Intermetallic compounds may be defined as solid phases containing two or more metallic elements, with optionally one or more non-metallic elements, whose crystal structure differs from that of the other constituents. The Hume-Rothery rules may be used to predict solid phase solutions. en.wikipedia.org/wiki/Hume-Rothery_rules, www.phase-trans.msm.cam.ac.uk/2004/titanium/hume.rothery.html.

The definition of a metal is taken to include the so-called post-transition metals, i.e., aluminum, gallium, indium, thallium, tin and lead, some, if not all, of the metalloids, e.g., silicon, germanium, arsenic, antimony and tellurium, and homogeneous and heterogeneous solid solutions of metals, but interstitial compounds of metals (such as carbides and nitrides) are excluded under this definition. However, interstitial intermetallic compounds are included, as are alloys of semimetal compounds with a metal. For purposes hereof, the phrase “intermetallic” compounds also encompasses certain intermetallic-like compounds, i.e., crystalline metal compounds other than halides or oxides, and including such semimetals, carbides, nitrides, borides, sulfides, selenides, arsenides, and phosphides, and can be stoichiometric, and share similar properties to the intermetallic compounds defined above, including the facilitation of layer adhesion. Thus, compounds such as cementite, Fe₃C, are included. See, en.wikipedia.org/wiki/Intermetallic. The interfacial layer may have amorphous characteristics, e.g., due to rapid cooling.

### SUMMARY OF THE INVENTION

Additively manufactured materials are typically of low thermal conductivity compared to bulk materials. This technology makes a high thermal conductivity material which would be useful for heat transfer parts like heat sinks, heat exchangers, or many other aerospace and automotive components. In particular, it could double the thermal conductivity compared to existing materials, which means smaller temperature gradients and more efficient fins. This leads to less material needed, and hence lower weight and less volume, which is our value proposition to industry. For instance, in aero and defense, weight on a plane and weight on a rocket/satellite directly translates into money saved in fuel.

This technology can be used to make macro- to micro-sized cooling devices, e.g., with features defined by the resolution of the fabrication process. This technology can be used to build-up cooling devices that make use of lattices, fins, fins that also direct flow to beneficial effect. These features might have additional processing to create additional roughness or porosity by etching. The features may also be dynamic, i.e., change configuration with temperature and deflect in response to force, such as due to fluid flow, vibration, or electromagnetic fields.

This technology also can make features with variable porosity that enables wicking and heat pipes. The porosity can be modulated by varying the power used or maximum temperature or energy source exposure time during processing, and is spatially controlled. Or the porosity can be modified post-processing by acid-based removal of the base metal, possibly variably more on the outer surface and less spatially controllable unless there are barrier layers presented. Varying porosity can also be achieved to provide more fluid along major arteries and greater capillary pumping through smaller capillaries that fan out from the artery.

Cooling devices can be standalone features that are cut off a buildplate, or made directly onto the integrated circuit substrate/electronic chip, or an existing cooling device made by other means (including heat spreader, integrated heat spreader and lid, heat pipe, vapor chamber). Features can also be added to the exterior surface of a tool (e.g., grinding instrument) for grinding and thermal purposes.

Macro-sized additively manufactured cooling features can incorporate lattices, fins, or fin arrays, for instance, where the advantage of lattices relative to fins come from the structural reinforcement of cross-elements. The features can have varying thickness versus height, so they are thicker at the bottom and thinner at the top to maximize surface area and minimize volume and weight. The bottom surface, if printed onto a smooth substrate, can benefit from a thin coating of diamond-metal film everywhere, and then the heatsink above, when the application will involve two-phase cooling (e.g., boiling or evaporation). This initial coating of diamond metal film on the initial substrate adds a conduction thermal resistance that can be outweighed by the lowering of boiling resistance through additional boiling nucleation sites, and lower onset of initial boiling temperature (lower thermal hysteresis during power cycling).

This technology can also be applied to conventionally made cooling devices by way of a coating, porous coating, lattice, fins. Using this technology to deposit thin film coatings with diamonds sticking out (exposed diamonds or coated exposed diamonds) can provide both additional surface area for convection, including two-phase convection (e.g., boiling). These features can lower superheating for boiling, reduce transients for startup by retaining bubble nuclei.

The technology need not be employed in isolation, and for example, heat removal devices that incorporate diamond particles may be formed on a substrate or layer having pyrolytic graphite fins protruding vertically out of the material, that could be beneficial to create lightweight high thermal conductivity heat sinks.

The structures may also be formed on substrates intended to form micromechanical devices (MEMS) or other mechanical structures, such as motors, actuators, tools, and the like. In some cases, the process forms diamond-containing structures which direct heat flow, such as heat transport layers in a planar coating, heat transport vias extending vertically through layers, and the like.

The technology makes use of additives to increase the thermal conductivity of additively manufactured metals in a novel manner that enhances thermal conductivity beyond that of currently available materials on market. In particular, the technology adds a highly thermal conductive material, industrial diamond, and uses a thin interlayer between the diamond and a metal matrix that enhances the heat transfer between the metal and the high thermal conductivity additives. Prior diamond-metal laser powder bed fusion materials suffer lower thermal conductivity than the bulk metal matrix due to poor wetting and low interfacial thermal conductance. The present technology overcomes this limitation so that thermal conductivities can be enhanced. In particular, an in situ formed thin interlayer is employed that bridges the diamond-metal interface. The in situ formed interlayer acts as a heat transfer enhancer by bridging the phonon spectra of the diamond and the phonon spectra of the metal. In other embodiments, a pre-formed interlayer (formed prior to laser powder bed fusion) is used, though that will tend to be thicker and less performing. One embodiment of the invention also aligns the diamond microparticles using magnetic particle coating, to improve percolation.

The diamond has anisotropic mechanical properties, and therefore if the particles are coated with a magnetic material and selectively magnetized along an axis of interest, the particles may be selectively oriented by an external magnetic field during manufacturing, to provide a structured anisotropic material, or in some cases, a metamaterial.

The material is heterogeneous and formed of fused metal particles forming a matrix, with diamonds interspersed through the matrix. The fill of diamond material is preferably sufficiently high that there is diamond/diamond contact or diamond-coating/coating-diamond contact. The matrix is preferably copper or silver, or perhaps aluminum, zinc, tungsten, rhodium, molybdenum, magnesium, iridium, chromium, or beryllium. Preferably, the diamond inclusions increase the thermal conductivity (in contrast to {52}), while reducing the coefficient of thermal expansion of the bulk material.

The present technology may provide methods for additively manufacturing ultra-high thermal conductivity cooling devices through printing diamond metal composites directly onto electronic substrates with low residual thermal stresses. Prior studies on high thermal conductivity diamond metal composites have focused on infiltration of liquid metal into diamond powders via vacuums or high-pressure. One reference found that thermal conductivity as high as 640 W/m-K is possible via these conventional manufacturing methods {6,7}; however these methods cannot be applied directly to electronic substrates and cannot make thin additively manufactured features or variable porosity/density. Past research did not extensively explore the choice of carbide, though it did find that carbide interlayers improve conductivity over no interlayer {6-8}.

In the nanoscale thermal transport literature, the work of Monachon and Weber studied sputtered metal films on diamond, and suggest that thinner carbide interlayers produce comparable contact resistance as a thicker layer {9}. This supports the concept that thinner interlayers should result in lower conduction resistance owing to their <10 nm of thickness. Prior patents {1,2} and research articles {3-5} by the inventors detailed how to print mechanically robust metal features onto silicon, pyrolytic graphite, and glass using a printed interlayer followed by aluminum or copper.

The present technology enhances metal carbide-diamond thermal interfacial transport, especially in additively manufactured thin carbide interfaces. The technology enables superior thermal conductivity cooling features to be formed directly on the electronic devices by selective laser melting of diamond metal composites. This enables diamond to be laser powder bed printed. It also lowers the thermal coefficient of expansion of the metal, which can help in aiding matching properties of metals to lower-CTE substrates (like semiconductor materials).

Fundamentally, the thermal energy passing through this additively manufactured diamond metal composite needs to convert from predominantly electronic thermal transport in the metal to phononic transport in the diamond. In this conversion process, the mismatch between the phonon frequencies carrying thermal energy will lead to interfacial resistance. The present technology enables greater phononic frequency overlap of the carbide interlayer with diamond to improve the interfacial thermal conductance between the diamond and the metal matrix, and therefore enhance bulk thermal conductivity. Using an interfacial carbide layer that is as stiff as possible, so it has more phononic overlap with diamond than the metal matrix, increases the interfacial conductance and the resulting composite thermal conductivity.

Another embodiment employs magnetically functionalized diamond particles to agglomerate and stay as a connected network in the molten alloy state (below the Curie temperature), to reduce thermal resistance and allow higher diamond volume fractions.

Another embodiment provides tuning enhanced boiling through modification of the diamond penetration through the metal matrix.

This technology permits the diamond-metal composite matrix to be printed onto the chip to potentially reduce the thermal resistance 0.1-0.2° C. cm²/W from current best-in-class commercial technologies, which can lead to significantly cooler devices (40° C. at 200 W/cm² background heat flux). This enhanced cooling stems from a thermal resistance reduction of ˜0.1° C. cm²/W at the package interfaces (US20220055153A1; U.S. Pat. No. 11,167,375), and a reduction in the heatsink resistance of about ˜0.1° C. cm²/W due to higher conductivity fins and improved design (according to the present technology). The technology can enhance reliability by about >10× while shrinking the size and weight of the cooling device by over 50%, compared to conventional cooling devices. Alternatively, this enhanced cooling can boost performance 20-50% with unchanged reliability. These estimates are owing to electronic devices becoming ˜5% more efficient and doubling their mean time to failure for a 10° C. reduction in silicon transistor temperature. Industrial diamond is cost effective in this application.

One embodiment fabricates a 3D printed diamond metal matrix composite of high thermal conductivity. In certain embodiments, it also enables the manufacture of heat removal devices consisting of diamond-metal mixtures printed directly onto the electronic device via selective laser melting. This technique has the advantage of increasing the thermal conductivity of printed structures which results in better cooling. Additionally, thermal stresses due to mismatch of the coefficient of thermal expansion between the printed structure and semiconductor substrate are reduced which improves the reliability of the thermal management device and the electronic component.

Prior research found that Sn_{0.93}Ag_{0.03}Ti_{0.04} reacts to form a thin titanium carbide surface layer that enables the wetting of graphite {4}, and a similar bonding reaction can be used to print onto diamond. The brazing literature and thermodynamic properties indicate a similar bonding is expected with laser printed diamond metal composite {89}. Diamond metal matrix prints well with the SnAgTi alloy, as shown in FIGS. 6A-6B. Surface microscopy show that diamond is well wetted by the SnAgTi and voids were not present.

Printing of diamond with copper alloyed with small concentrations of titanium can form a similarly thin carbide that forms in situ. The formation energy of TiCu₄ is −0.085 eV/atom, which is much less favorable than the formation energy of TiC −0.810 eV/atom (MaterialsProject.org), so carbide formation will be energetically favored. Small concentrations of Ti in an alloy can react with carbon-materials during melting, including diamond, to form a thin layer of carbide (e.g., 10 nm).

In an alternative embodiment, the diamond can be coated in titanium carbide ex situ, e.g., through the salt-bath method. This will improve the thermal transport by gradually shifting of the phonon modes from the metal into the diamond via an interlayer with an intermediate phonon spectra. The downside of the ex situ bath method is that the thickness of the interlayer may become quite thick, which presents unnecessary conduction resistance, while the downside of Ti alloying of Cu is a reduction in Cu thermal conductivity, though this can be managed by using small concentrations of Ti that can almost fully react to form carbides or precipitate out as intermetallics.

Moreover, improved percolation of diamond thermal conduction pathways can be made through coating these particles in a magnetic material. This magnetic material needs to have a Curie temperature greater than the melt temperature. Cobalt, which has a Curie temperature of 1121° C., is greater than Cu's melting point of 1085° C., Ag's melting point of 961° C., and aluminum's melting point 660° C., can serve this purpose. This magnetic attraction can reduce the average conduction path length and conduction resistance inter-diamond particles.

The present technology improves the thermal conductivity of laser powder bed fused metals. This technology is of particular interest to applications that would benefit from higher conductivity, namely heat transfer, grinding/tooling applications, and applications that benefit from low coefficient of thermal expansion metal composites.

This technology can also be applied to metal-infused polymeric additive manufacturing, especially fused deposition modeling. Polymeric binder that can be removed can be mixed with metal powder that is alloyed to react to form an interlayer, as described earlier, and diamond, so that when the plastic is removed via burnout or chemical removal, the sintering and densification of the metal with incorporated diamond and metal-carbide interlayers can be formed. These interlayers around the diamond can also be done ex situ and then compounded with polymer and diamond.

It is therefore an object to provide a heatsink, formed of a heterogeneous material comprising a metal matrix comprising at least one of copper and silver in an amount of at least 50% by weight; and diamond particles having a metal carbide interlayer in the metal matrix, wherein the heterogeneous material has a thermal transfer coefficient of greater than the thermal transfer coefficient of the metal matrix, and preferably a coefficient of thermal expansion less than the metal matrix. For example, the metal matrix may be copper, and the thermal transfer coefficient is greater than 400 W/m-K. Note that while pure silver has a thermal transfer coefficient of 429 W/m-K, alloys have a lower thermal transfer coefficient.

It is also an object to provide a powder material for additively manufacturing a structure, comprising metal particles and diamond particles, wherein the powder is fusible with heat to form a heterogeneous solid structure having enhanced thermal conductivity and lower coefficient of thermal expansion with respect to a homogeneous specimen of the metal alone. The diamond particles may be coated with metal carbide. The metal carbide may be formed in situ during the heating, as a reaction product with the metal particles, or may be provided as a coating on the diamond particles before sintering or fusion. The metal particles may comprise metal alloy particles comprising at least 50% of at least one of copper and silver. The metal particles may comprise an amount between 0.01%, 0.02%, 0.03%, 0.04%, 0.05%, 0.06%, 0.07%, 0.08%, 0.09%, 0.1%, and up to 10% by weight of at least one of Ti, Zr, V, Nb, Hf, Ta, Mo, Cr, and W, effective to form the in situ metal carbide on the surface of the diamond particles at a fusion temperature of the metal particles.

It is a further object to provide a method for fabrication metal structures, comprising receiving a substrate; depositing a powder on a surface of the substrate, the powder comprising metal particles and diamond particles; heating the deposited powder to a fusion or sintering temperature with an energy source to fuse or sinter the powder; and cooling the fused or sintered powder to form a heterogeneous solid, wherein the diamond particles are in situ or ex situ coated with a metal carbide and dispersed in the heterogeneous solid.

The substrate may comprise a packaged semiconductor, and the cooled fused or sintered powder is configured as a thermal dissipation structure. The substrate may comprise a semiconductor, and the metal particles react with the semiconductor at the fusion or sintering temperature to form an interfacial intermetallic composition. The substrate may comprise at least one of silicon, a silicide, silica, gallium arsenide, gallium nitride, boron nitride, and a ceramic.

The diamond particles may be thin film coated with at least one of Ti, Zr, V, Nb, Hf, Ta, Mo, Cr, and W.

The metal particles may comprise copper or silver alloyed with between 0.01% and 10% of at least one of Ti, Zr, V, Nb, Hf, Ta, Mo, Cr, and W.

The heterogeneous solid may be configured as a set of mechanically reinforced high thermal conductivity metal structures.

The substrate comprises an optical communication medium, and, for example, be transparent to optical waves at a communication wavelength.

The substrate may comprise a surface interlayer having a different composition than a bulk of the substrate, the interlayer adhering to the substrate and adhering to the heterogeneous solid.

The method may further comprise etching a surface of the heterogeneous solid, generating heat in the substrate, and transferring the heat to a liquid at the etched surface.

The diamond particles are coated with a magnetic cobalt layer. The magnetic cobalt layer may be used to manipulate the diamond particles during fusion of sintering to align or reposition the diamond particles, for example to increase anisotropic thermal conductivity along a preferred axis.

The powder may be selected from the group consisting of steel, copper, silver, aluminum, titanium, zinc, tungsten, rhodium, molybdenum, magnesium, iridium, chromium, or beryllium.

The diamond particles may be pretreated to form a metal carbide layer of at least one of titanium carbide, chromium carbide, zirconium carbide, tungsten carbide on the diamond particles.

The metal carbide layer may be formed by treatment of the diamond particles in a salt bath, a nanodeposition technique, or sputtering.

The heating may be achieved by one of powder bed selective laser fusion, directed energy deposition, electron beam melting, and welding.

It is also an object to provide metal-diamond composites formed using laser powder bed fusion with the diamond that is coated in a metal-carbide film (e.g., titanium carbide, chromium carbide, zirconium carbide, tungsten carbide) prior to laser exposure.

It is also an object to provide metal-diamond composites using laser powder bed fusion with the diamond that is coated in a metal-carbide film that forms due to laser exposure (e.g., titanium carbide, chromium carbide, zirconium carbide, tungsten carbide).

It is a still further object to provide functionalized diamond coated with a magnetic material to enable greater percolation of diamonds through the system.

It is another object to provide varied interfacial bonding layers (e.g., laser formed thin carbides, and pre-formed carbides).

In certain embodiments, the technology implements additive manufacturing with a diamond-containing matrix containing a highly conductive metal (e.g., Cu, Ag) and a small concentration a metal carbide forming metal element (e.g., Ti, Cr, Zr).

The diamond can be in situ carbided during the additive manufacturing process heating step.

The diamond can be ex situ carbided prior to additive manufacturing. This can be done by salt-bath coating.

Diamonds may be coated in a magnetic coating to attract diamonds to one another and lower inter-diamond thermal resistance.

In other embodiments, the metal alloy can also include concentrations in certain embodiments of low melt point alloys, like SnAg, plus a metal carbide forming metal element.

The diamond-metal mixtures can be heterogeneous, consisting of mixtures of powder of high thermal conductivity metal, metal carbide forming metal, and diamond.

The diamond-metal mixtures can contain pre-mixed or alloyed metal. That is, the high thermal conductivity metal and metal carbide forming metals can be mixed via a process like plasma or arc gas atomization.

The diamond can be provided in a mixtures of sizes, with large diamonds (˜>10 μm) to carry heat without having to pass frequent interfaces, and some smaller diamonds to bridge voids between diamonds. For example, 50% of the diamond may be >10 μm, and the remainder in smaller sizes. It is noted that the heterogeneous diamonds may be subject to different formation of the interface layers in different ways. For example, the larger diamonds may be ex situ coated in a salt bath, while the smaller diamonds in situ coated.

Other high thermal conductivity crystals may be used as well. For example, silicon carbide and boron nitride crystals may also be used.

These alloys can be used to print high thermal conductivity and low-CTE structures for stand-alone use.

These alloys can be used to print high thermal conductivity and low-CTE structures for use directly onto electronic substrates, like silicon, GaN, SiC, etc.

The additively manufactured composite can be made by selective laser melting.

The additively manufactured printed composite can be made by directed energy deposition.

The additively manufactured printed composite can be made by electron beam additive manufacturing.

For deposition on a silicon wafer, it is preferred that the deposited metal matrix, and in particular the initial deposited layers, form a metal silicide that improves adhesion and form a thermally-conductive interface layer. The matrix may thus include both the metal-silicide reactive material, diamond, and metal-carbide reactive material. The metal-silicide reactive material and the metal-carbide reactive material may advantageously be the same. Similarly, deposited matrices on other substrates may react with the substrate to form a respective intermetallic composition.

It is an object to provide a material for additively manufacturing a structure, comprising metal or metal alloy particles; and diamond particles, wherein the metal or metal alloy particles and diamond particles are together sinterable, and are adapted to form a carbide layer on the diamond particles under sintering conditions of the metal or metal alloy particles.

It is an object to provide a material for additively manufacturing a structure, comprising metal or metal alloy particles; diamond particles; and a polymer, wherein the polymer is removable and the metal or metal alloy particles and diamond particles are together sinterable.

The diamond particles may comprise a metal carbide outer layer. The metal or metal alloy particles may comprise a metal adapted when heated to a fusion temperature to react with diamond to form a metal carbide layer on the diamond particles.

It is a further object to provide a method for additively manufacturing a structure, comprising additively forming a protostructure comprising metal or metal alloy particles, and diamond particles; and sintering the metal or metal alloy particles and the diamond particles, wherein the sintered diamond particles have a metal carbide coating.

It is a still further object to provide a method for additively manufacturing a structure, comprising additively forming a protostructure comprising metal or metal alloy particles, diamond particles, and a polymer; removing the polymer; sintering the metal or metal alloy particles and the diamond particles, wherein the sintered diamond particles have a metal carbide coating. The metal carbide coating may form during the sintering, or the protostructure may comprise the diamond particles having the metal carbide coating.

This diamond plus high thermal conductivity metal powder and optionally metal silicide reactive metal powders can be incorporated into a polymer. This polymer-metal-diamond composite can then be additively formed. This polymer can then be removed thermally or chemically. The fused material can then be sintered. Sintering can proceed in an inert or reducing atmosphere. The diamond particles may be precoated with a metal carbide layer, or the metal carbide layer may form during sintering.

This polymer-metal-diamond composite can be fused deposition additively manufactured.

This polymer-metal-diamond composite can be stereolithographically printed where the polymer resin is liquid and hardens under selectively light exposure (e.g., a UV curable epoxy, siloxane, or other polymer).

This polymer-metal-diamond composite can be binder jet printed, and subsequently sintered.

This polymer-metal-diamond composite can be selectively fused by layerwise selective pigment dye application and sintering.

This polymer-metal-diamond composite can be injection molded.

The method may further comprise reheating the portion of the powder deposited on the substrate with the localized energy source, to enhance formation of the interlayer, and subsequently cooling the regionally remelted portion of the powder to reform the solid layer.

The localized energy source may heat the region above the melting temperature for a duration of less than about 60 seconds, or 30 seconds, or 20 seconds, or 20 seconds, or 5 seconds, or 2.5 seconds, or 1 second, or about 100 milliseconds, or 10 milliseconds, or 1 millisecond, or 100 microseconds, or 25 microseconds, for example.

The localized energy source may heat the region for a duration of less than about 60 seconds, or 30 seconds, or 20 seconds, or 20 seconds, or 5 seconds, or 2.5 seconds, or 1 second, or about 100 milliseconds, or 10 milliseconds, or 1 millisecond, or 100 microseconds, or 25 microseconds, for example.

The localized energy source may be pulsatile or continuous. The localized energy source may be dynamically repositioned over the surface, during exposure or between pulses of exposure. The powder may comprise a metal powder, e.g., having a melting temperature of less than 1600° C., or 1500° C., or 1400° C., or 1300° C., or 1250° C., or 1200° C., or 1100° C., or 1000° C., or 900° C., or 800° C., or 700° C., or 600° C., or 500° C., or 400° C., or 375° C., or 350° C., or 325° C., or 300° C., or 290° C., or 285° C., or 280° C., or 270° C., or 260° C., or 250° C., or 240° C., or 230° C., or 220° C., or 210° C., or 200° C., or 190° C., or 180° C., or 170° C., or 160° C., 150° C., or 140° C., or 130° C., or 125° C., or 120° C., 110° C., 100° C., or 90° C., or 80° C., or 79° C., or 75° C., for example. Formation of a metal carbide at the surface of a diamond may require achieving fusion temperatures of the metal.

The metal matrix may also be filled with moissanite (silicon carbide), which has a thermal conductivity equal or greater than diamond. Synthetic moissanite can be made from thermal decomposition of a preceramic polymer poly(methylsilyne). Therefore, the silicon carbide may be formed in situ during laser sintering.

The metallic powder may chemically react with a silicon or carbon substrate to form an intermetallic or intermetallic-like compound. The powder may chemically react with the dissimilar material to form a metal carbide or metal silicide compound. The powder may chemically react with the dissimilar substrate in an anoxic or inert environment, such as argon, helium or nitrogen gas.

At least one of the powder and the dissimilar substrate may be flammable in air, especially under conditions of focused laser or electron beam irradiation. To avoid combustion, air may be excluded from the reaction space. On the other hand, controlled combustion may be used in the reaction as appropriate. At least one of the powder and the dissimilar substrate may be pattered by modulating a flow of reactive gas, such that regions exposed to the focused energy beam in the presence of the reactive gas have different properties than regions exposed to the focused energy beam in the absence of the reactive gas. The modulated property may be porosity, hydrophilicity/hydrophobicity, adhesion to subsequent layers of fused metal or metal particles, bubble liftoff, surface roughness, electrical conductivity, thermal conductivity, optical refractive properties, optical reflective properties, optical absorption properties, frictional coefficient, chemical reactivity, wear-resistance, etc.

The powder may melt to form a metal layer having less than about 1% void space. The melted powder may have a density of at least 99% of a theoretical value.

The heating may comprise selective laser melting (SLM), electron beam exposure, or other techniques.

The dissimilar substrate may comprise pyrolytic carbon, graphite, silicon, an integrated circuit wafer, stainless steel, 316L stainless steel (Fe, <0.03% C, 16-18.5% Cr, 10-14% Ni, 2-3% Mo, <2% Mn, <1% Si, <0.045% P, <0.03% S), a gallium arsenide wafer, an integrated circuit formed on a semiconductor wafer, a microprocessor formed on a silicon wafer, silicon carbide, diamond, a diamond-like coating, gallium oxide, a material with a conductive transparent substrate (indium tin oxide, indium zinc oxide, graphene), silica glass, quartz, borosilicate glass, molybdenum disilicide, tungsten borides, dissimilar metal, a heatsink or other materials, devices or structures.

The solid layer may be part of a stack of solid layers formed above the bonding surface.

The stack of solid layers may define a bounded space. The bounded space may define a fluid flow channel. The fluid flow channel may comprise a microchannel heat exchanger. The fluid flow channel may comprise a phase change heat pipe.

The stack of solid layers may be homogenous or heterogeneous. The stack of solid layers may have a composition gradient. The stack of solid layers may have a composition discontinuity. The stack of solid layers may comprise a low melting point solder.

The dissimilar substrate may be non-metallic and the solid layer may be metallic.

The solid layer may have a first melting point, and a second solid layer is formed over the solid layer having a second melting point, the second melting point being higher than the first melting point, wherein heating the dissimilar substrate to a temperature between the first melting point and the second melting point causes a loss of material integrity between the dissimilar substrate and the second solid layer, making the second solid layer separable from the dissimilar substrate.

The preferred embodiment is a localized energy source that may comprise a laser beam or an electron beam. Alternative embodiments could use an energy source that is less localized, like a microwave energy source, an infrared heating element, or a heated stylus (e.g., soldering iron tip), possibly with a template or mold providing finer detailing on where material should bond to the substrate.

The powder may comprise a metal having between about 0.1% and 10% by weight aggregate, and preferably at least 1%, of at least one of Ti, Zr, V, Nb, Hf, Ta, Mo, Cr, and W. Various metals form silicide compounds, including Sc, Ti, V, Cr, Mn, Fe, Co, Ni, Cu, Y, Zr, Nb, Mo, Ru, Rh, Pd, Hf, Ta, W, Re, Os, Ir, Pt, La, Ce, Pr, Nd, Sm, Eu, Gd, Tb, Dy, Ho, Er, Yb, Lu, Th, U, Np, Pu, Am, and Cm. Therefore, these components may be present within the powder to be processed, and potentially form silicides that enhance adhesion to a silicon substrate. Some of these would only be useful in very particular circumstances, for example, Np, Am and Cm might find application in high-cost tolerant situations where one seeks a future release of the solid metal from the silicon, as might result from radioactive decay of the silicides that promote adhesion. Some of these same silicide forming elements also promote bonding to silica materials like ceramics composed of silica, quartz, borosilicate glasses, lithium aluminum silicate glass-ceramics.

While high thermal conductivity metal matrixes (Cu, Ag), with a small amount of reactive material (Ti) are preferred, in other embodiments, the matrix is different. For example, the powder may comprise a solder alloy selected from the group consisting of at least two of Sn, Pb, Ag, Cu, Sb, Bi, In, Zn, Cd, Au, Ni, Si, Ge, Si, and Al. The powder may comprise a solder alloy selected from the group consisting of InSn (e.g., In₅₂Sn₄₈, In₆₀Sn₄₀, In₅₀Sn₅₀, In₄₂Sn₅₈), InCd (e.g., In₇₄Cd₂₆), BiPbInCdSn (e.g., Bi_{44.7}Pb_{22.6}In_{19.1}Cd_{5.3}Sn_{8.3}), InBiSn (e.g., In₅₁Bi_{32.5}Sn_{16.5}), InBiCd (e.g., In_{61.7}Bi_{30.8}Cd_{7.5}), BiPbSnIn (e.g., Bi₄₉Pb₁₈Sn₁₂In₂₁), BiPbSnCd (e.g., Bi₅₀Pb_{26.7}Sn_{13.3}Cd₁₀), BiSnIn (e.g., Bi₅₆Sn₃₀In₁₄), BiPbSn (e.g., Bi₅₂Pb₃₂Sn₁₆, Bi₅₀Pb_{31.2}Sn_{18.8}), BiPb (e.g., Bi₅₈Pb₄₂), SnPbBi (e.g., Sn₄₆Pb₄₆Bi₈), InSnPbCd (e.g., In₇₀Sn₁₅Pb_{9.6}Cd_{5.4}), SnPbIn (e.g., Sn₅₄Pb₂₆In₂₀, Sn_{37.5}Pb_{37.5}In₂₅, Sn₇₀Pb₁₈In₁₂), BiSnAg (e.g., Bi₅₇Sn₄₂Ag₁), BiSn (e.g., Bi₅₆Sn₄₂, Bi₅₈Sn₄₂), SnBiPb (e.g., Sn₄₈Bi₃₂Pb₂₀, Sn₄₃Pb₄₃Bi₁₄), CdSn (e.g., Cd₇₀Sn₃₀), InPbAg (e.g., In₈₀Pb₁₅Ag₅), InAg (e.g., In₉₇Ag₃. In₉₀Ag₁₀), SnPbCd (e.g., Sn_{51.2}Pb_{30.6}Cd_{18.2}), InPb (e.g., In₇₅Pb₂₅, In₇₀Pb₃₀, In₆₀Pb₄₀, In₅₀Pb₅₀, Pb₇₅In₂₅), In, PbSnZn (e.g., Pb₆₃Sn₃₄Zn₃), SnZnInBi (e.g., Sn_{86.5}Zn_{5.5}In_{4.5}Bi_{3.5}), SnInAg (e.g., Sn_{77.2}In₂₀Ag_{2.8}, Sn_{86.9}In₁₀Ag_{3.1}, Sn_{91.8}In_{4.8}Ag_{3.4}. Sn₈₈In_{8.0}Ag_{3.5}Bi_{0.5}), SnZnCd (e.g., Sn₄₀Zn₂₇Cd₃₃), SnPbZn (e.g., Sn₃₀Pb₅₀Zn₂₀), PbSnAg (e.g., Pb₅₄Sn₄₅Ag₁, Sn₆₂Pb₃₆Ag₂, Pb₈₀Sn₁₈Ag₂, Pb₉₆Sn₂Ag₂, Pb₈₈Sn₁₀Ag₂, Pb₉₂Sn_{5.5}Ag_{2.5}, Pb₉₀Sn₅Ag₅, Pb_{93.5}Sn₅Ag_{1.5}, Pb_{95.5}Sn₂Ag_{2.5}), SnZnIn (e.g., Sn_{83.6}Zn_{7.6}In_{8.8}), PbSn (e.g., Pb₉₀Sn₁₀, Pb₈₅Sn₁₅, Pb₈₀Sn₂₀, Sn₆₃Pb₃₇, Sn₇₀Pb₃₀, Sb₉₀Pb₁₀, Sn₆₃Pb₃₇P_{0.0015-0.04}, Sn₆₂Pb₃₇Cu₁, Sn_{97.5}Pb₁Ag_{1.5}), SnZnBi (e.g., Sn₈₉Zn₈Bi₃), SnZn (e.g., Sn₉₁Zn₉, Sn₈₅Zn₁₅, Sn₆₀Zn₄₀, Zn₇₀Sn₃₀, Zn₆₀Sn₄₀, Sn₅₀Zn₄₉Cu₁, Sn₉₀Zn₇Cu₃), SnBiAg (e.g., Sn_{91.8}Bi_{4.8}Ag_{3.4}), SnAgCu (e.g., Sn_{96.5}Ag_{3.0}Cu_{0.5}, Sn_{95.5}Ag_{4.0}Cu_{0.5}, Sn_{95.8}Ag_{3.5}Cu_{0.7}, Sn_{95.6}Ag_{3.5}Cu_{0.9}, Sn₉₉Cu_{0.7}Ag_{0.3}, Sn_{96.2}Ag_{2.5}Cu_{0.8}Sb_{0.5}, Sn_{90.7}Ag_{3.6}Cu_{0.7}Cr₅, Sn₉₅Ag_{3.5}Zn₁Cu_{0.5}, Sn_{95.5}Cu₄Ag_{0.5}, Sn₉₇Cu_{2.75}Ag_{0.25}), SnAu (e.g., Sn₉₀Au₁₀), SnAg (e.g., Sn_{96.5}Ag_{3.5}—Sn₉₃Ag₇), SnCu (e.g., Sn_{99.3}Cu_{0.7}, Sn₉₇Cu₃), SnPbZn (e.g., Sn₃₃Pb₄₀Zn₂₈), Sn, SnSb (e.g., Sn₉₅Sb₅—Sn₉₉Sb₁), SnAgSb (e.g., Sn₆₄Ag₂₅Sb₁₀), PbIn (e.g., Pb₈₁In₁₉, Pb₇₀In₃₀, Pb₇₅In₂₅, Pb₉₀In₅Ag₅, Pb_{92.5}In₅Ag_{2.5}, Pb_{92.5}In₅Au_{2.5}), CdZn (e.g., Cd_{82.5}Zn_{17.5}, Cd₇₀Zn₃₀, Cd₆₀Zn₄₀, Zn₉₀Cd₁₀, Zn₆₀Cd₄₀,Cd₇₈Zn₁₇Ag₅), Bi, AuSn (e.g., Au₈₀Sn₂₀), PbSbSn (e.g., Pb₈₀Sb₁₅Sn₅), PbAg (e.g., Pb_{94.5}Ag_{5.5}—Pb₉₆Ag₄, Pb₉₇Ag_{1.5}Sn₁, Pb_{97.5}Ag_{2.5}), CdAg (e.g., Cd₉₅Ag₅), AuSi (e.g., Au₉₈Si₂, Au_{96.8}Si_{3.2}), ZnAl (e.g., Zn₉₅Al₅), ZnSn (e.g., Zn₉₅Sn₅), Zn, AuIn (e.g., Au₈₂ In₁₈), AuGe (e.g., Au_{87.5}Ge_{12.5}). The powder may comprise Sn₃Ag₄Ti, or an AgCuTi alloy. The powder may comprise an Ag₂₁Cu₅X alloy where X=Ti, Ta, Zr, V, Hf, Cr, Mo, W, and Nb. The powder may comprise a Cu alloy having between about 0.1% and 10% by aggregate weight of X=Ti, Ta, Zr, V, Hf, Cr, Mo, W, and Nb. The powder may comprise an Al alloy having between about 0.1% and 10% by aggregate weight of X=Ti, Ta, Zr, V, Hf, Cr, Mo, W, and Nb.

The localized energy source may be a 1064 nm Yb-fiber laser. A position of the localized energy source may be controlled by a galvanometer mirror system. The localized energy source may have a heating zone of less than 300 μm deep.

The solid layer bonded to the dissimilar substrate may comprise a heat spreader for a heat dissipative device.

It is an object to provide a powder material for additively manufacturing a structure, comprising metal particles; and non-metallic particles with thermal conductivities greater than 100 W/m-K and coefficient of thermal expansion less than 10 ppm/degree C., wherein the metal particles are fusible with heat to form a heterogeneous solid structure around the non-metallic particles with an intermetallic compound interface, the heterogeneous solid structure having enhanced thermal conductivity and lower coefficient of thermal expansion with respect to a homogeneous specimen of the fused metal particles alone.

The metal particles and non-metallic particles may be adapted to form the intermetallic compound interface in situ on a surface of the non-metallic particles at a fusion temperature of the metal particles.

The non-metallic particles may comprise diamond particles, and the intermetallic compound interface may be formed in situ as a metal carbide on a surface of the diamond particles during a fusion of the metal particles to form the heterogeneous solid structure.

The metal particles may comprise metal alloy particles of at least 50% of at least one of copper and silver, and an amount between 0.1% and 10% by weight of at least one of Ti, Zr, V, Nb, Hf, Ta, Mo, Cr, and W, effective to form a metal carbide in situ in a surface of diamond particles during a processing of the powder material at a fusion temperature of the metal particles.

The non-metallic particles may be coated with the intermetallic compound interface prior to fusion of the metal particles to form the heterogeneous solid structure.

The non-metallic particles may comprise metal carbide coated diamond particles.

It is also an object to provide a method for fabrication metal structures, comprising receiving a substrate; depositing a powder on a surface of the substrate, the powder comprising metal particles and non-metallic particles with thermal conductivities greater than 100 W/m-K and coefficient of thermal expansion less than 10 ppm/degree C.; heating the deposited powder to a fusion or sintering temperature of the metal particles with an energy source, to fuse or sinter the powder; and cooling the fused or sintered powder to form a heterogeneous solid, wherein the non-metallic particles are in situ or ex situ coated with an intermetallic compound and dispersed in the heterogeneous solid.

The substrate may comprise a packaged semiconductor, and the cooled fused or sintered powder is configured as a thermal dissipation structure.

The substrate may comprise a semiconductor, and the metal particles react with the semiconductor at the fusion or sintering temperature to form an interfacial intermetallic composition.

The nonmetallic particles may comprise diamond particles, which are thin-film coated with at least one of Ti, Zr, V, Nb, Hf, Ta, Mo, Cr, and W.

The metal particles may comprise at least one of copper and silver alloyed with between 0.01% and 10% of at least one of Ti, Zr, V, Nb, Hf, Ta, Mo, Cr, and W.

The substrate may comprise at least one of silicon, a silicide, silica, gallium arsenide, gallium nitride, boron nitride, and a ceramic.

The substrate may comprise an optical communication medium.

The substrate may comprise a surface layer having a different composition than a bulk of the substrate, the surface layer adhering having greater adhesion to the substrate and to the heterogeneous solid than an adhesion of the substrate to the heterogeneous solid.

The nonmetallic particles may comprise diamond particles coated with a magnetic cobalt layer. The magnetic cobalt layer advantageously has a Curie temperature above a fusion or sintering temperature of the metal particles, and therefore permit magnetic orientation and alignment of the diamond particles during fusion.

The metal powder may be selected from the group consisting of aluminum, titanium, steel, silver and copper, and alloys thereof.

The nonmetallic particles may be pretreated to form a metal carbide surface layer comprising at least one of titanium carbide, chromium carbide, zirconium carbide, and tungsten carbide before the heating.

The method may further comprise treating the nonmetallic particles with at least one of a salt bath process, a nanodeposition process, and a sputtering process to form a surface layer of the intermetallic compound before the heating.

The heating may be one of powder bed selective laser fusion, directed energy deposition, electron beam melting, and welding.

It is a further object to provide a heatsink, formed of a heterogeneous material comprising a metal matrix comprising at least one of copper and silver in an amount of at least 50% by weight; and nonmetallic particles having an intermetallic compound carbide interlayer forming heterogeneous inclusions in the metal matrix, wherein the heterogeneous material has a net thermal transfer coefficient of at least 430 W/m-K. Pure silver has a thermal transfer coefficient of 429 W/m-K, highest of any metal, and therefore the inclusion of nonmetallic particles will increase the thermal transfer coefficient of the heterogeneous metal matrix of the fused metal and nonmetallic particles. The intermetallic carbide interlayer may improve a thermal phonon transfer efficiency between the metal matrix and the nonmetallic particle. Prior composites with diamond inclusions did not reliably form an interlayer, and therefore were unable to effectively exploit the high thermal transfer coefficient of diamond particles or other inclusions.

It is another object to provide a method of forming a heatsink for an integrated circuit, comprising depositing a metallic powder with diamond particles on an integrated circuit substrate; and locally heating the metallic power to a sufficient temperature to melt the metallic powder with focused energy, having limited duration at a particular region to avoid heat-induced functional damage to the integrated circuit, and cooling the melted metallic powder to form a solid layer, to form an adherent bond between the integrated circuit substrate and the solid layer, and an adherent interface between the diamond and the metal matrix.

The adherent bond to the substrate may comprise a metal silicide component interlayer.

The locally heating may comprise exposing the metallic powder to radiation pulses, and/or spatially scanned radiation.

The locally heating may remelt and subsequently cool regions of the solid layer.

The method may further comprise depositing a second metallic powder over the solid layer, the second metallic powder being different from the metallic powder; and locally heating the second metallic power to a sufficient temperature to melt the second metallic powder, substantially without heat-induced functional damage to the integrated circuit, while forming an alloy interlayer between the melted second metallic powder and the solid layer.

It is a further object to provide a method for forming a selectively melted metal structure, comprising providing a substrate having a bonding surface; depositing a first powder comprising components of a fused low melting temperature metal, having a composition that, when heated, chemically reacts with the substrate; heating the first powder, on the substrate, with localized energy source to melt the powder and the low melting temperature metal, and to react with the bonding surface, sufficient to form a bonding interlayer; depositing a second powder comprising components of a high melting temperature metal and diamond particles, having a composition that, when heated, forms an alloy interlayer with the lower melting temperature metal substrate; and heating the second powder, as well as a thermally conductive interface between the high melting temperature metal and the diamond, on the fused low melting temperature metal, with localized energy pulses to fuse the second powder, and to alloy with the fused low melting temperature metal. The low melting temperature metal helps avoid thermal damage to the substrate during the initial deposition.

It is another object to provide a metal alloy powder for use in additive manufacturing, comprising a particles of metal or metal alloy, and diamond particles, and a reactive material that forms an interface layer between the diamond particles and metal or metal alloy during melting or sintering.

It is also an object to provide a method for forming a structure bonded to a substrate, comprising providing a substrate; forming an interlayer by chemical reaction on the substrate, between the substrate and a metal layer; depositing a metallic powder containing diamond particles on the metal layer; heating a portion of the metallic powder deposited on the substrate with a localized energy source in a localized heating region, the localized energy source being dynamically controlled to regionally melt the portion of the metallic powder substantially while leaving an adjacent portion of the metallic powder unmelted, and without bringing the substrate underneath the localized heating region into thermal equilibrium; and cooling the regionally melted portion of the metallic powder to form a solid layer. The cooling may occur concurrently with heating of a different portion of the metallic powder deposited on the surface with the localized energy source, to regionally melt the different portion of the metallic powder.

The localized energy source may be operated continuously and be dynamically repositioned over the surface. The powder may chemically react with the surface of the substrate and/or the diamond particles to form at least one of an intermetallic compound, a metal carbide compound, a metal nitride compound, a metal boride compound, and a metal silicide compound. A location of the localized heating region may be controlled over time to selectively melt the powder into a predefined patterned layer having gaps between portions of the solid layer. The heating may comprise selective laser melting (SLM). The substrate may comprise a semiconductor. The surface of the substrate may comprise a silver, gold, copper or aluminum layer.

The method may further comprise forming a stack of layers over the solid layer above the bonding surface, by sequentially depositing a powder on an upper surface and melting the powder, in a predetermined pattern, to form a three-dimensional structure which adheres to the substrate.

It is a further object to provide a method of forming a structure on an integrated circuit, comprising depositing a powder on a surface of a substrate comprising an integrated circuit; and locally heating the powder to a sufficient temperature to melt the powder with focused energy, having limited duration at a particular region to avoid heat-induced functional damage to the integrated circuit, and cooling the melted powder to form a solid layer, wherein an adherent bonding layer is present between the substrate and the solid layer comprising a chemical reaction product distinct from a composition of the surface and a composition of the solid layer.

The adherent bonding layer may comprise an interlayer selected from the group consisting of an intermetallic compound, a metal silicide, a metal carbide, a metal boride, and a metal nitride, and the solid layer comprises a metal or metal alloy, and the method further comprise forming a stack of additional solid layers over the solid layer in a regional pattern to form a three dimensional structure having at least one space over the substrate between respective portions of the regional pattern, while avoiding heat-induced functional damage to the integrated circuit.

Another object provides a device, comprising a fused layer, formed by a process comprising depositing a powder on a supporting surface of a substrate, comprising a metal or metal allow and non-melting particles; and locally heating a portion of the powder on the supporting surface with a focused energy beam, substantially without achieving thermal equilibrium in the substrate, to fuse the locally heated portion of the powder to form an adhesion interlayer.

The adhesion layer may be formed substantially without concurrently fusing a non-locally heated portion of the powder, configured as a region-specific pattern.

The adhesion interlayer may comprise a heating-induced chemical reaction product of the powder.

The region-specific pattern of the device may be configured as a heat sink.

The fused volume may have a surface with adjacent regions of heterogeneous aqueous fluid wetting, wherein regions with high wettability promote aqueous liquid flow to bubble generation sites, and regions with low wettability promote bubble liftoff. The region-specific pattern may define a circumferential wall of a microchannel configured to guide fluid flow.

The powder may comprise a metal alloy, and between about 0.1% to about 10% aggregate weight, per weight of the metal alloy, and preferably at least 1% by weight, of a reactive element that bonds actively to the substrate surface and/or diamond particles selected from the group consisting of Ti, Ta, Zr, V, Hf, Cr, Mo, W, and Nb.

A further object provides a manufactured structure, comprising a substrate; an interface layer, comprising a chemical reaction product of the metallic composition and particles within the structure; and a solid matrix, formed adjacent to the interface layer from fused portions of the powder, in a regional pattern.

The substrate may comprise an integrated circuit having a deposited metal layer, the solid layer is metallic, the fused interface layer comprises an intermetallic composition, and the regional pattern is configured as a heatsink for the integrated circuit.

The solid layer may be formed by fusion of a powder that chemically reacts with the surface to form the interface layer comprising at least one of an intermetallic compound, a metal carbide compound, a metal nitride compound, a metal boride compound, and a metal silicide compound.

The substrate may comprise a semiconductor. The semiconductor may be configured as an integrated electronic circuit, and wherein the solid layer is configured as a set of electrically-isolated electrical interconnects to the integrated electronic circuit.

A still further object provides an adhesive interlayer between a particle or substrate and a fused metal alloy powder, comprising a chemical reaction product comprising at least one of a metal silicide, a metal carbide, a metal boride, and a metal nitride with a respective substrate, the chemical reaction product forming a shear resistant layer which causes the fused metal alloy powder to adhere to the particle or substrate. The layer may have a high thermal transfer coefficient, and facilitate heat transfer through the resulting object.

The chemical reaction product may be selected from the group consisting of an intermetallic compound, an intermetallic-like compound, or a chalcogen bond compound.

The powder may consist essentially of a AgX or CuX alloy, where X is a reactive element selected from the group consisting of Ti, Ta, Zr, V, Hf, Cr, Mo, W, and Nb in an amount of between about 0.1% to about 10% by weight.

The powder may consist essentially of an AgCuX alloy, where X is a reactive element selected from the group consisting of Ti, Ta, Zr, V, Hf, Cr, Mo, W, and Nb in an amount of between about 0.1% to about 10% by weight, where Cu is about 35% by weight and Ag is the balance.

The powder may consist essentially of a Cu alloy comprising copper and additional alloying elements, and non-metallic particles, wherein the additional alloying elements are provided in an effective amount to reactively bond with the non-metallic particles to form the intermetallic or intermetallic-like compound. The additional alloying elements may comprise at least one of Ti, Ta, Zr, V, Hf, Cr, Mo, W, and Nb in weight percentages from about 0.1-10 wt %, the Cu alloy being at least 50% by weight Cu.

The locally heating may be performed by controlling a focused laser, to determine an optimal laser processing power, an optimal scan rate, and an optimal fused volume thickness, for each of a plurality of layers of powder formed on the dissimilar substrate, by rastering multiple scan rates and laser processing power on test parts for each layer thickness, and inspecting the test parts to determine the optimum processing conditions, and subsequently employing the determined optimum processing conditions on other parts. The testing may comprise a visual inspection and/or thermal testing of the test parts.

The powder may comprise the metal alloy, and between about 0.1% to about 10% aggregate weight, per weight of the metal alloy, of a reactive element that bonds actively to the substrate surface. The reactive element may be one of more element selected from the group consisting of Ti, Ta, Zr, V, Hf, Cr, Mo, W, and Nb. The reactive element may facilitate bonding to non-metallic particles selected from the group consisting of Si, SiC, SiN, graphite, diamond, carbon nanotubes, graphene, fullerenes, GaN, GaAs, βGa₂O₃, gallium oxide, Al₂O₃, and SiO₂ (glass and quartz), silica glass, quartz, borosilicate glass, aluminosilicate glass, lithium aluminum silicates, indium tin oxide, indium zinc oxide, molybdenum disilicide, tungsten boride, gallium arsenide, zinc sulfide, beryllia, ceria, zirconia, indium tin oxide, and indium zinc oxide.

It is another object to provide a powder material for additively manufacturing a structure, comprising diamond particles; and metal alloy particles comprising at least 50% of at least one of copper and silver, and an effective amount of at least one of Ti, Zr, V, Nb, Hf, Ta, Mo, Cr, and W to form a carbide on a surface of the diamond particles at a fusion temperature of the metal particles, wherein the powder is fusible to form a heterogeneous structure having enhanced thermal conductivity and lower coefficient of thermal expansion with respect to the metal alone. The effective amount may comprise between about 0.1% and 10% by weight aggregate of at least one of Ti, Zr, V, Nb, Hf, Ta, Mo, Cr, and W.

The powder, at a fusion temperature, may form an in situ metal carbide at a surface of the diamond particles.

It is also an object to provide a method for fabrication of high conductivity metal structures comprising a metal matrix and diamond particles dispersed in the metal matrix, onto an electronic chip, comprising depositing a powder on a surface of the chip, the powder comprising a metal and diamond particles; heating the powder to a fusion or sintering temperature with an energy source; and cooling the fused or sintered powder, wherein the diamond particles are in situ or ex situ coated with a metal carbide.

It is a still further object to provide a method for fabrication of high thermal conductivity metal structures comprising a metal matrix and diamond particles dispersed in the metal matrix, onto a substrate, comprising depositing a powder on a surface of the substrate, the powder comprising a metal and diamond particles; heating the powder to a fusion or sintering temperature with an energy source; and cooling the fused or sintered powder, wherein the diamond particles are in situ or ex situ coated with a metal carbide.

The diamond particles may be thin film coated with at least one of Ti, Zr, V, Nb, Hf, Ta, Mo, Cr, and W.

The substrate may be an integrated circuit, a heat spreader, a two-dimensional heat spreader, or a heatsink. The substrate may be selected from the group consisting of a nitride, a silicide, a ceramic, and silica. The substrate may be optically transmissive, and for example, may be a fiber optic. The substrate may comprise at least one of gallium arsenide, gallium nitride, and boron nitride. The high thermal conductivity metal structures formed on the substrate may be configured as a heat spreader, a two-dimensional heat spreader, or a heatsink.

It is another object to provide a method for fabrication of structures comprising a metal matrix and diamond particles dispersed in the metal matrix, comprising printing or spray coating a patterned layer on a surface, the layer comprising metal particles and diamond particles; and processing the layer to achieve a fusion or sintering of the metal particles, wherein the diamond particles are in situ or ex situ coated with a metal carbide.

The layer (i.e., before processing) may comprise diamond particles comprising the metal carbide coating. The diamond particles may also react with during the processing to form the metal carbide coating.

It is a further object to provide a method for fabrication of high thermal conductivity metal structures comprising a metal matrix and diamond particles dispersed in the metal matrix, onto a substrate, comprising printing or spray coating a layer on a surface of the substrate, the layer comprising metal particles and diamond particles; and processing the layer to achieve a fusion or sintering of the metal particles, to form the metal matrix with the diamond particles dispersed in the metal matrix, adherent to the substrate, wherein the diamond particles are in situ or ex situ coated with a metal carbide.

The diamond particles may be thin film coated with at least one of Ti, Zr, V, Nb, Hf, Ta, Mo, Cr, and W. The diamond particles may be thin film coated with Co, which is a high Curie temperature magnetic coating, that advantageously can be used to align the diamond particles and form chains during the processing. The alignment and chaining can improve heat transport by reducing gaps between diamond particles. Alternately, the particles may be anisotropic, such as multilayered carbon nanotubes, which can also be magnetically aligned by coating with a magnetic film coating.

The substrate may be an integrated circuit, and the high thermal conductivity metal structures are configured as a heat spreader or heatsink to dissipate heat from the integrated circuit.

The substrate may be selected from the group consisting of gallium arsenide, gallium nitride, boron nitride, other nitride, a silicide, a ceramic, and silica, and the metal particles react with the substrate during the processing.

The surface of the substrate may comprise an interlayer having a different composition than a bulk of the substrate.

The printing or spraying and processing comprise an additive manufacturing process.

It is a still further object to provide a method of dissipating heat from an integrated circuit, comprising fabricating a set of high thermal conductivity metal structures comprising a metal matrix and diamond particles dispersed in the metal matrix, onto a surface of the integrated circuit, wherein the diamond particles are in coated with a metal carbide; generating heat within the integrated circuit, which passes through the surface into the metal structures, wherein a thermal conductivity of the high thermal conductivity metal structures is at least 10% greater than a thermal conductivity of the metal matrix alone; and transferring the heat from the high thermal conductivity metal structures to a surrounding thermal transfer medium. The diamond particles may be coating with a magnetic coating and then magnetically aligned within the high thermal conductivity metal structures.

The high thermal conductivity metal structures may be mechanically reinforced. For example, metal, carbon, or ceramic fibers may be interspersed in the matrix formed by fusing or sintering the metal particles. The high thermal conductivity metal structures may comprise a metal matrix, diamond particles coated with a metal carbide, and mechanical reinforcement structures.

The surface of the substrate may comprise an interlayer having a different composition than a bulk of the substrate.

The fused or sintered powder has a textured surface having a surface area of greater than 1.1 per square. The surface of the fused or sintered powder may be etched.

The method may further comprise boiling a liquid with heat from the substrate at the etched surface.

The substrate may be an integrated circuit, the fused or sintered powder comprises a heatsink, and the method may further comprise packaging the substrate with the heatsink exposed.

The fused or sintered powder may be formed by an additive manufacturing process into a three dimensional structure.

The diamond particles may be pretreated in a molten salt bath to form a layer of titanium carbide.

The diamond particles may be coated with a magnetic cobalt layer.

The diamond particles may be coated with chromium carbide.

The fused or sintered powder may comprise an aluminum, titanium, or steel matrix.

In some embodiments, the process may include a powder that includes a flux to make a paste.

In some embodiments, the material can be formed via a powder forming step. The forming step can embody the usage of a mask. The deposition can be further modified in some embodiments by a stamp. The deposition can be sintered or fused by means of a conveyor belt reflower (e.g., Heller convection reflow oven), or by laser soldering tool, or by a laser-rastered reflow tool.

The initial substrate upon which the additively formed object is made can be a temporary substrate from which it is later separated. The temporary substrate can be something like Teflon that survives the process temperature, or a metal that is non-wetting to the metal being reflown or easily removable (graphite, US 20200049415A1). The pre-reflowed object in some embodiments can be formed through a process that involves electroplating.

In some embodiments, the structure is made to have a pattern of small islands of structure, so the length of any deposition is smaller than the overall structure. This reduces the maximum stresses when attached to a large device, that imparts larger stresses on larger structures.

While diamond is the preferred embodiment for additive in terms of thermal performance, the technology also embodies the use of graphitic materials including graphene, multi-layer graphene, carbon nanotubes, that would also benefit from carbide formation, as an alternative to diamond. Alternatively, boron-nitride materials could be used instead of diamond, like multi-layer hexagonal boron nitride. The boron nitride materials can react with elements (e.g., Ti) to form titanium-nitride bond. All of these alternative inclusion materials would lower CTE, and have high thermal conductivity relative to conventional solder materials.

### BRIEF DESCRIPTION OF DRAWINGS

FIG. 1A shows the diffuse mismatch model thermal boundary conductance estimate for diamond versus the Debye temperature of that material. The model predicts a 14× improvement in thermal boundary conductance for TiC compared to a direct Cu-Diamond interface.

FIG. 1B shows estimates of effective thermal conductivity vs volume fraction of diamond, thermal boundary conductance of interface and thermal conductivity of base matrix.

The upper curve represents upper range of interfacial conductance, while the lower curve represents the lower range. Diamond particles are 10 μm in diameter.

FIGS. 2A and 2B show transmission electron microscopy images of SnAgTi printed onto graphite revealing a ˜10 nm TiC layer formed at the interface during selective laser melting (phase confirmed by nanobeam diffraction).

FIG. 3A shows printing of diamond metal composites diamond-carbide interlayers formed during selective laser melting.

FIG. 3B shows printing of diamond metal composites with carbide interlayers formed before printing via molten salt synthesis approach.

FIG. 4 shows printing of diamond metal composites with magnetic interlayer to improve diamond alignment and thermal conductivity

FIG. 5 shows boiling occurring on diamond metal composite (such as diamond-copper composite) for enhancement due to diamond protruding into the fluid

FIGS. 6A-6B show warpage measurement of a package with flip-chip configuration via optical profilometry. FIG. 6A shows results of a large CTE mismatch between the silicon die and the high conductivity metal matrix composite. FIG. 6B shows results of diamond addition resulting in reduction of warpage and mechanical stresses on the die.

FIG. 7 shows industrial diamond in Sn0.93Ag0.03Ti0.04 matrix selective laser melted onto silicon wafer.

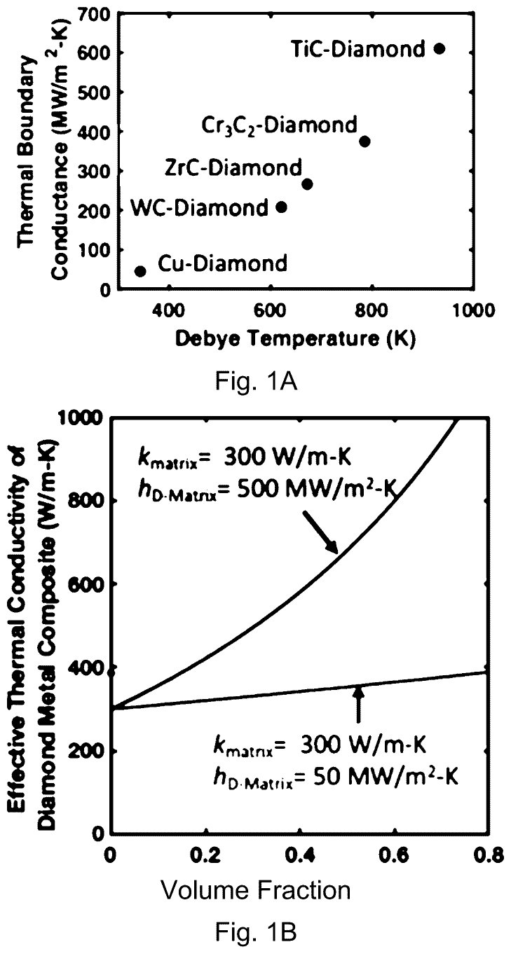

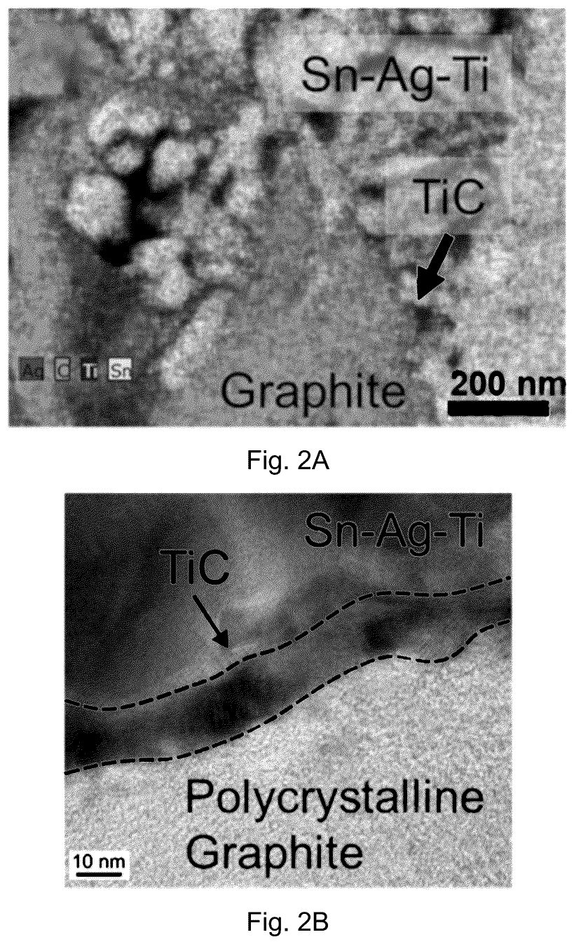

### DETAILED DESCRIPTION OF THE PREFERRED EMBODIMENTS

### Example 1

### Step 1: Prepare Pre-Cursors for Printing Diamond Metal Composites by Selective Laser Melting

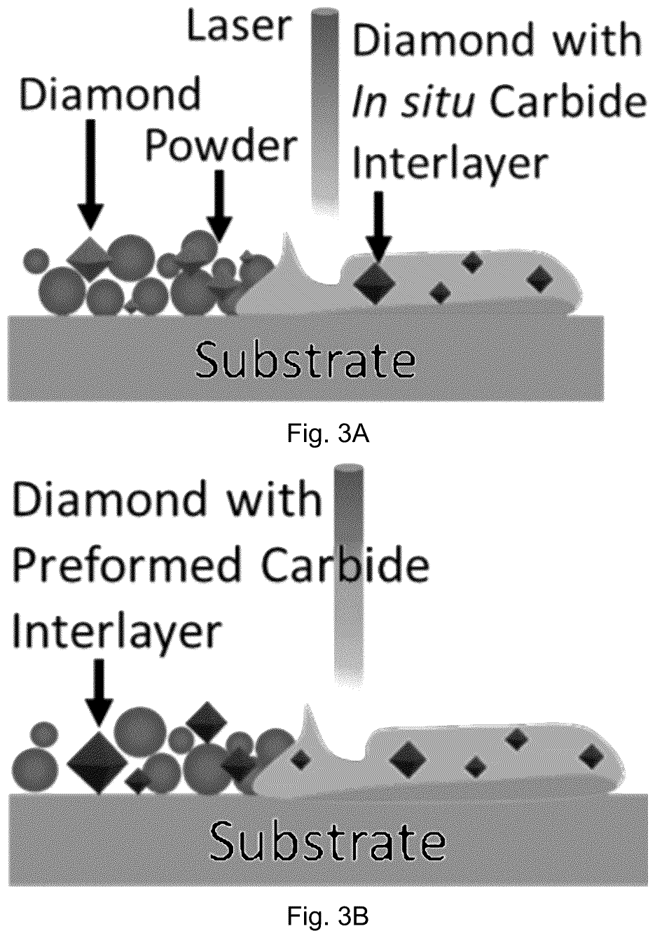

As shown in FIGS. 3A and 3B, there are two general preparation routes. One involves reacting the metal carbide forming metal during printing (in situ method, FIG. 3a), and before printing (ex situ method, FIG. 3b).

Rapid bonding on the time scale of selective laser melting may be achieved using a SnAgTi alloy to react to dissimilar substrates like silicon and pyrolytic graphite. During selective laser melting, this alloy in situ forms an interlayer of titanium silicide and titanium carbide on silicon and carbide, respectively. While the time to make a good bond in typical metal wetting is on the order of tens of minutes {72-75}, in additive manufacturing this nucleation and crystal growth of the interlayer phase needs to occur in times of less than 100 μs, as the laser melting and solidification occur rapidly. Rapid bonding is made possible by the hot local temperatures induced by laser heating. The spot directly under the laser beam can reach the boiling point of the alloy. This extra heat helps overcome the thermal barrier. The energy barrier for nucleation of the carbide and the energy barrier for diffusion of the reactive metal (eg Ti, Cr, Ta, Zr, V, W) have an Arrhenius rate dependence, exp(−Eₐ/k_{B}T), where N is the nucleation rate, Eₐ is the activation energy for diffusion or nucleation, k_{B} is the Boltzmann constant, and T is absolute temperature {76}. The highly localized temperatures during laser processing overcome this barrier without significantly heating the active side of the electronic device, as it is outside the thermal penetration depth {77-79}.

Reactive alloys (e.g., Cu—Ti) are prepared using plasma gas atomization that will react to form thin (˜10 nm) metal carbide interlayers on diamonds during selective laser melting. The small volume fraction of titanium will react with the copper to form intermetallics (e.g., TiCu, Ti₃Cu₄, Ti₂Cu) during the powder manufacturing. The titanium atoms will also diffuse to the diamond surface and form titanium carbides (e.g., TiC, Ti₈C₅, Ti₂C), as the titanium carbides have a more negative formation energies (i.e., −0.81 to −0.644 eV/atom) than the titanium-copper intermetallics (i.e., −0.085 to −0.136 eV/atom) {80}. To test the effect of the metal carbide interlayer type, copper alloys with different reactive bonding elements will also be created (e.g., Cu—Cr, Cu—V) to form interlayers of different compositions.

Diamonds coated with metal carbides in different forms can be compared in terms of thermal conductivity. The metal carbide will be formed by (a) in-situ during selective laser melting, and (b) by a thick molten salt processing. To form thicker metal carbides, the molten salt synthesis method is used, through which metal ions can diffuse, allowing for the formation of carbide films. By controlling the temperature of the molten bath and the time, the thickness of the carbide coating can be controlled. The metal ions are transferred to the salt bath via micron-sized metal powders added to the molten salt bath {81}.

Step 2: Print the Diamond Metal Composites with In-Situ and-Ex Situ Interlayer Carbiding.

The selective laser melting process can be performed by conventional laser powder bed fusion systems such as EOS M290 (400 W, 1064 nm). Powder (˜20 μm diameter) of the metal alloys mixed with diamond can be obtained commercially. The print recipe for novel materials is modified layer-by-layer through parameter editing software. This includes the optimal laser power, scanning speed, and hatch distance. A good energy density will react a thin interlayer, while not damaging the diamond and not spattering metal.

Printing of Diamond Metal Matrix Composites with Magnetic Coating

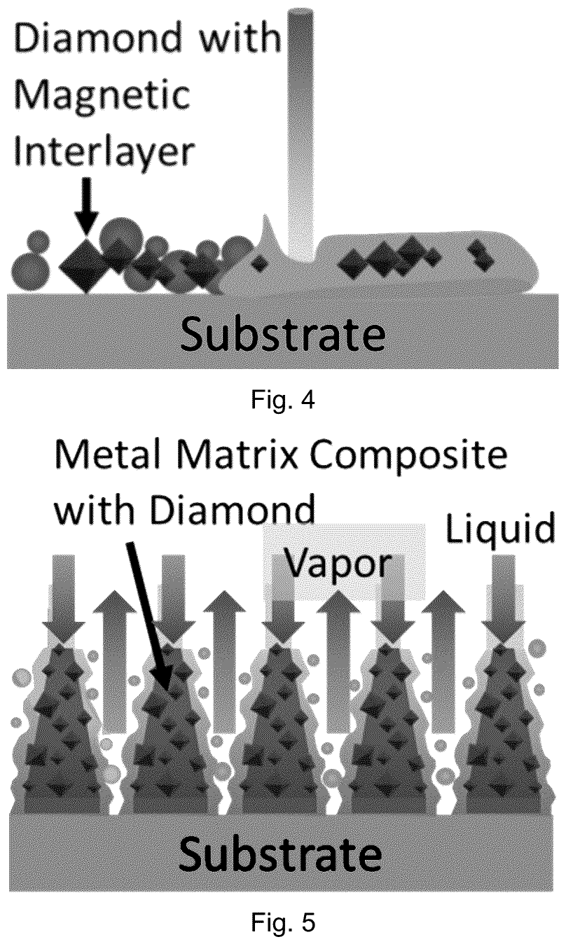

Additionally, diamonds can be coated in a thin magnetic coating, and selective laser melted into a metal matrix composite (FIG. 4). This enables testing if effective thermal conductivity can be improved through the agglomeration of diamond that creates thermal percolation pathways. The challenge to magnetic agglomeration is to have the melt pool be cooler than Curie temperature in order to maintain the attractive forces between diamonds. This is possible with a coating of cobalt on the diamond, as cobalt has Curie temperature of 1121° C., which is above the melting temperature for copper (1085° C.) and silver (961° C.). The magnetic force holding two hard magnet coated diamond particles is on the order of 400 μN, much smaller than fluid force that would shear the particles apart (˜1-10 μN) {82}.

Printing of Diamond Metal Matrix Composites with Varying Porosity and Shapes.

High-throughput testing of printed layers are conducted by printing multiple samples in one round of printing that varies porosity by varying the energy density of the laser exposure, and thickness of the wicking layer. Furthermore, external diamond penetration will be achieved on some of the samples by depositing a thin sparse coating of diamonds on top of the diamond matrix composite and re-exposing the surface. Partial wetting of the diamonds can be achieved by partially coating the diamond in a non-wetting metallization. Kaviany et al previously made boiling enhanced structures through templated sintering, {83-86} but was limited by the manufacturing method. The degree of porosity can be spatially tuned through the laser processing parameters, which enables exploring structures with fractal like arteries that reduce fluid flow resistance.

### CTE Matching Though the Addition of Diamonds

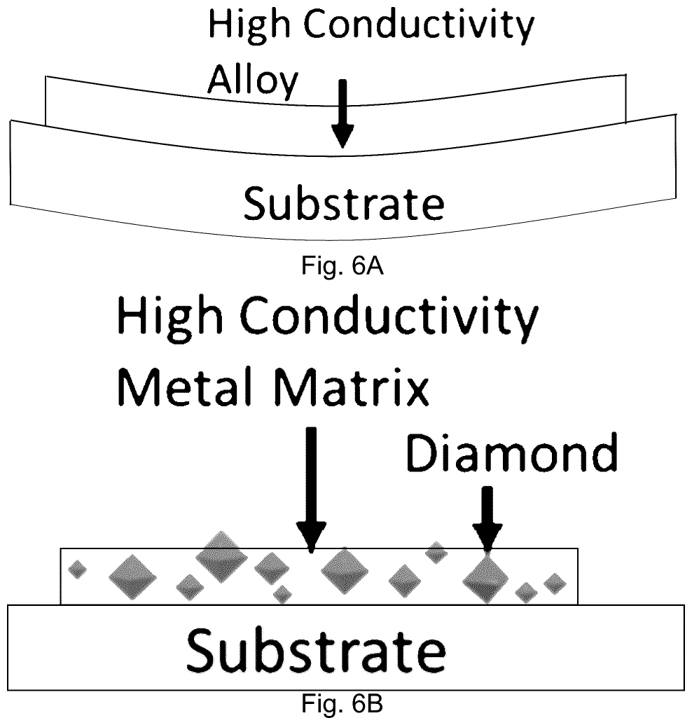

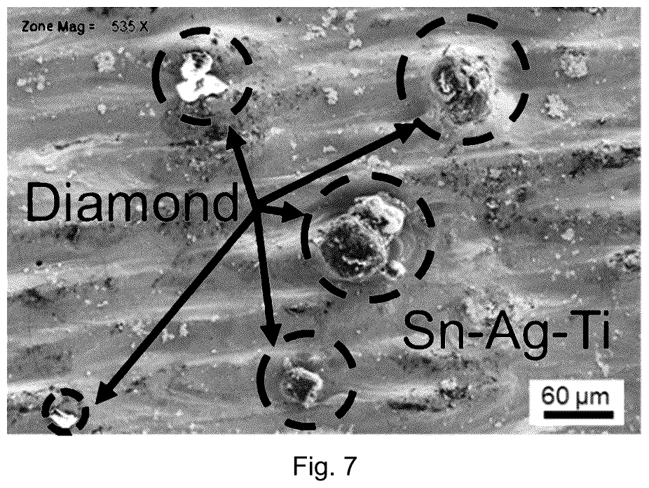

To enhance the thermal conductivity to levels never reached previously with prior additively manufactured metals, requires using metals like copper or silver as the metal matrix material, which have higher melting points than the alloys previously used, e.g., SnAgTi alloy. The increased melting point of copper over this tin alloy increases the temperature difference that drives residual thermal stresses, making lowering the CTE mismatch by diamonds critical to bonding this high thermal conductivity material directly onto electronic substrates of low CTE for electronics cooling (FIGS. 6A-6B). FIG. 6A shows warpage of a flip-chip package, which can be measured using optical profilometry, in which a large CTE mismatch between the silicon die and the high conductivity metal matrix composite causes flexion. FIG. 6B shows results of diamond addition resulting in reduction of warpage and mechanical stresses on the die.

By optimizing the process such that low residual stresses at the diamond composite-electronic substrate interface will remain after printing. Based on prior bulk fabricated diamond metal composites {87}, it is possible to reduce the CTE from 17 to ˜5 PPM, close to most power electronic substrates. Estimated effective coefficients of thermal expansion can be estimated from the Voigt and Reuss models that predict the upper and lower limits to the composites effective CTE.

It is possible to modify the composite to have additional CTE lowering compound, beyond diamond. In particular, hexagonal boron nitride nanoplatelets may be explored as an additive to lower CTE. The boron nitride is impervious to oxidation, has decent thermal conductivity and can survive selective laser melting without reacting with the metal matrix.

It is possible to mix the low CTE composite with higher CTE composite or pure material to beneficially induce stresses.

### Application to Reflow Process Compatibility

The additive manufacturing process can take the form of a forming step, followed by a reflow step. The forming step can take the form of a mask, like what is used for solder paste. Alternatively, the forming step can include the use of a mold or stamp that imprints a design, or a lithographic process to transfer material in a defined pattern, such as pad printing, see en.wikipedia.org/wiki/Pad_printing, or other gravure or intaglio printing process, see en.wikipedia.org/wiki/Rotogravure, en.wikipedia.org/wiki/Intaglio_(printmaking). The reflow process can accept powders as described above, plus the optional inclusion of a flux. The reflow can be in the form of a reflow oven, as common in electronics packaging, including a conveyor belt oven or laser reflow tool, or new laser tooling that is galvo steered.

The object can be formed on a temporary build plate and then transferred to the desired surface in separate steps, or formed directly on the desired surface. The benefit of producing the devices in two steps would be to make the device compatible with conventional reflowing, so the end-user would not need the forming step. The first reflow could be with laser powder bed fusion, laser soldering, or conventional reflow ovens, as can the second. In many embodiments, the factory producing the devices may be separate from the factory applying the devices to the electronic packages. The reflow can be controlled to sinter, rather than fully reflow, depending on settings for the reflow. The reflow settings, such as temperature of oven, or power of optical soldering station (laser or LED driven), laser power, and laser scan speed for steered laser, can be optimized by an empirical process. For example, a varying or incrementally varying set of test tabs, fabricated in a preliminary process, and tested according to a predetermined sufficiency or quality criterion, which may be automatically assessed. Because the optimum conditions may vary for each production lot, an automated control may perform in-process optimization, especially of laser characteristics and laser positional control algorithm, such as using a test tab substrate separable from the final product which can be processed initially and optically assessed to tune the process parameters.

In the twice reflowed process, the temporary substrate can separated by pulling the part off while the bottom is heated, or by using a substrate that is poorly wetted.

### Example 2

### Application to Tooling

The embedded particle matrix has abrasive properties. Therefore, the particle embedded matrix may be used in various tools. The embedded particle matrix is advantageous because it has a high thermal conductivity, and therefore can sustain significant cutting or grinding loads without overheating. The interlayer also helps retain the abrasive particles within the matrix, and therefore increases tool life. The matrix may be relatively soft as compared to tool steel.

The disclosure has been described with reference to various specific embodiments and techniques. However, many variations and modifications are possible while remaining within the scope of the disclosure.

### INCORPORATION BY REFERENCE

Each reference cited herein is expressly incorporated by reference in its entirety for all purposes, and in particular without limitation are available to describe details of embodiments, explain the meaning of words and phrases, and provide support for the breadth of the following claims.

Additive manufacturing references: U.S. Pat. Nos. 4,748,085; 4,863,538; 4,938,816; 4,944,817; 5,053,090; 5,076,869; 5,132,143; 5,147,587; 5,155,321; 5,155,324; 5,156,697; 5,182,170; 5,207,371; 5,281,789; 5,296,062; 5,316,580; 5,382,308; 5,431,967; 5,433,280; 5,544,550; 5,597,589; 5,616,294; 5,622,577; 5,639,070; 5,730,925; 5,957,006; 6,046,426; 6,085,122; 6,143,378; 6,144,008; 6,202,734; 6,215,093; 6,261,493; 6,341,952; 6,391,251; 6,397,922; 6,454,811; 6,459,069; 6,476,343; 6,583,379; 6,596,224; 6,629,559; 6,676,892; 6,730,252; 6,756,561; 6,767,499; 6,811,744; 6,814,823; 6,830,643; 6,925,346; 6,930,278; 6,995,334; 7,020,539; 7,034,246; 7,043,330; 7,045,738; 7,212,095; 7,305,367; 7,537,664; 7,695,248; 7,705,264; 7,716,802; 7,777,155; 7,968,026; 8,021,138; 8,071,007; 8,124,245; 8,211,226; 8,268,099; 8,268,100; 8,326,024; 8,359,744; 8,372,330; 8,375,581; 8,383,985; 8,387,229; 8,394,168; 8,457,930; 8,479,393; 8,480,754; 8,488,994; 8,509,933; 8,513,562; 8,535,049; 8,546,717; 8,556,981; 8,556,983; 8,575,513; 8,598,523; 8,606,540; 8,610,761; 8,617,661; 8,623,026; 8,642,965; 8,666,142; 8,671,726; 8,678,802; 8,685,520; 8,690,472; 8,691,333; 8,718,522; 8,728,387; 8,728,807; 8,735,773; 8,740,598; 8,746,013; 8,753,105; 8,775,133; 8,790,858; 8,801,418; 8,809,780; 8,821,060; 8,822,875; 8,826,511; 8,828,311; 8,844,877; 8,875,976; 8,879,957; 8,906,107; 8,915,728; 8,916,085; 8,926,706; 8,931,171; 8,931,880; 8,952,678; 8,974,539; 8,985,497; 8,986,234; 8,992,703; 9,020,788; 9,023,566; 9,029,058; 9,034,048; 9,061,465; 9,073,150; 9,073,260; 9,073,261; 9,073,262; 9,075,409; 9,079,248; 9,079,355; 9,079,386; 9,090,428; 9,102,099; 9,107,725; 9,112,272; 9,114,478; 9,114,567; 9,120,270; 9,126,365; 9,126,367; 9,133,429; 9,141,015; 9,144,940; 9,144,961; 9,149,952; 9,149,988; 9,156,205; 9,156,240; 9,157,465; 9,157,735; 9,168,697; 9,180,010; 9,186,270; 9,186,846; 9,186,848; 9,192,990; 9,192,999; 9,196,760; 9,199,044; 9,199,345; 9,204,945; 9,205,204; 9,211,669; 9,221,100; 9,222,932; 9,227,339; 9,227,365; 9,228,859; 9,233,506; 9,248,611; 9,254,535; 9,269,520; 9,278,483; 9,279,328; 9,283,593; 9,296,039; 9,296,129; 9,302,338; 9,308,583; 9,308,691; 9,310,188; 9,315,043; 9,320,620; 9,326,780; 9,327,056; 9,327,350; 9,327,447; 9,327,452; 9,327,453; 9,332,251; 9,341,467; 9,346,116; 9,346,127; 9,347,770; 9,352,421; 9,358,350; 9,364,888; 9,369,259; 9,370,896; 9,375,298; 9,375,782; 9,387,079; 9,390,312; 9,399,256; 9,399,264; 9,399,321; 9,403,235; 9,406,483; 9,414,501; 9,415,438; 9,419,502; 9,421,715; 9, 423,756; 9,439,767; 9,440,397; 9,442,105; 9,442,395; 9,446,475; 9,452,474; 9,452,489; 9,453,142; 9,456,777; 9,456,901; 9,457,428; 9,457,521; 9,460,557; 9,463,506; 9,481,931; 9,482,103; 9,482,974; 9,486,878; 9,486,944; 9,486,964; 9,499,779; 9,507,061; 9,507,274; 9,508,667; 9,511,543; 9,511,547; 9,512,544; 9,517,134; 9,523,934; 9,527,165; 9,527,240; 9,527,242; 9,527,244; 9,527,246; 9,528,705; 9,528,902; 9,533,350; 9,533,372; 9,533,450; 9,533,485; 9,533,526; 9,543,116; 9,545,669; 9,555,475; 9,555,612; 9,556,415; 9,557,331; 9,557,661; 9,561,622; 9,561,623; 9,566,758; 9,570,789; 9,573,193; 9,573,224; 9,573,225; 9,578,695; 9,579,718; 9,579,829; 9,579,851; 9,583,856; 9,586,285; 9,586,290; 9,586,298; 9,586,364; 9,587,317; 9,592,530; 9,598,606; 9,603,711; 9,604,280; 9,617,865; 9,623,512; 9,625,156; 9,626,608; 9,636,229; 9,636,769; 9,636,770; 9,636,775; 9,636,868; 9,642,727; 9,643,281; 9,643,361; 9,649,690; 9,656,429; 9,662,840; 9,664,504; 9,664,505; 9,669,583; 9,676,145; 9,676,159; 9,676,963; 9,682,166; 9,688,028; 9,690,286; 9,694,423; 9,694,545; 9,696,142; 9,707,717; 9,708,440; 9,713,843; 9,714,318; 9,715,563; 9,718,127; 9,720,363; 9,721,384; 9,721,755; 9,731,377; 9,732,239; 9,737,934; 9,744,722; 9,744,730; 9,751,610; 9,757,802; 9,764,418; 9,764,515; 9,765,727; 9,770,758; 9,770,760; 9,770,866; 9,771,400; 9,771,629; 9,772,621; 9,775,680; 9,776,243; 9,776,282; 9,776,376; 9,777,385; 9,782,932; 9,782,935; 9,783,718; 9,783,885; 9,785,064; 9,788,600; 9,795,541; 9,796,048; 9,802,253; 9,808,991; 9,815,118; 9,815,139; 9,815,268; 9,821,399; 9,821,411; 9,821,546; 9,822,045; 9,827,754; 9,828,679; 9,833,839; 9,833,949; 9,833,987; 9,836,883; 9,838,018; 9,839,977; 9,849,510; 9,849,543; 9,850,172; 9,855,369; 9,855,625; 9,855,698; 9,861,452; 9,862,146; 9,868,255; 9,869,734; 9,873,180; 9,873,228; 9,873,281; 9,873,761; 9,877,790; 9,878,497; 9,882,111; 9,885,987; 9,890,091; 9,896,944; 9,897,513; 9,902,112; 9,902,588; 9,903,214; 9,903,574; 9,904,223; 9,915,583; 9,919,111; 9,919,112; 9,919,273; 9,919,360; 9,919,361; 9,919,479; 9,920,433; 9,922,759; 9,925,714; 9,925,724; 9,926,427; 9,931,695; 9,931,697; 9,931,814; 9,932,841; 9,933,718; 9,937,580; 9,943,981; 9,944,021; 9,945,032; 9,950,367; 9,950,465; 9,953,899; 9,956,047; 9,956,048; 9,956,107; 9,956,612; 9,956,725; 9,956,727; 9,959,613; 9,962,767; 9,969,000; 9,969,153; 9,969,930; 9,970,824; 9,975,179; 9,975,199; 9,975,296; 9,975,323; 9,981,425; 9,982,164; 9,982,684; 9,987,798; 9,987,804; 9,988,720; 9,993,976; 9,993,982; 9,994,339; 9,996,981; 9,999,920; 10,000,023; 10,005,227; 10,005,228; 10,005,230; 10,005,237; 10,011,076; 10,011,089; 10,011,352; 10,016,262; 10,016,661; 10,016,942; 10,018,937; 10,022,614; 10,023,739; 10,029,422; 10,029,424; 10,029,461; 10,035,306; 10,035,920; 10,039,195; 10,040,239; 10,040,240; 10,040,250; 10,040,252; 10,040,810; 10,045,835; 10,046,494; 10,046,521; 10,046,524; 10,052,159; 10,052,691; 10,054,530; 10,058,920; 10,059,053; 10,059,057; 10,059,092; 10,059,595; 10,060,217; 10,061,221; 10,064,745; 10,065,270; 10,065,367; 10,065,371; 10,068,863; 10,071,422; 10,076,875; 10,076,876; 10,081,129; 10,086,564; 10,087,556; 10,089,413; 10,091,891; 10,093,039; 10,096,537; 10,099,309; 10,099,427; 10,105,902; 10,105,906; 10,112,345; 10,112,379; 10,118,054; 10,118,337; 10,123,807; 10,124,408; 10,124,410; 10,124,532; 10,124,539; 10,131,088; 10,131,131; 10,132,578; 10,135,109; 10,136,689; 10,137,634; 10,137,636; 10,137,642; 10,144,178; 10,144,205; 10,144,828; 10,144,840; 10,145,271; 10,149,505; 10,150,258; 10,151,049; 10,151,377; 10,153,608; 10,155,882; 10,156,185; 10,157,503; 10,160,061; 10,160,193; 10,172,400; 10,173,945; 10,174,205; 10,174,276; 10,179,640; 10,182,869; 10,183,330; 10,183,443; 10,183,477; 10,189,057; 10,189,114; 10,189,204; 10,189,210; 10,189,239; 10,190,244; 10,190,955; 10,195,629; 10,195,693; 10,200,834; 10,201,409; 10,201,931; 20010008230; 20010008317; 20020015654; 20030114936; 20030116542; 20030206820; 20040056022; 20040099996; 20040133298; 20040191106; 20050133527; 20050174208; 20060032838; 20060081571; 20060147332; 20060166159; 20060185473; 20070134096; 20070141375; 20070142914; 20070151087; 20070183918; 20070203584; 20080008894; 20080052904; 20080201008; 20080210413; 20080213718; 20080317951; 20090206065; 20090283501; 20090286008; 20100010638; 20100068464; 20100125356; 20100143601; 20100221567; 20100242843; 20100262054; 20100262272; 20100291286; 20100291401; 20100305742; 20110014081; 20110016939; 20110029093; 20110047799; 20110061591; 20110087332; 20110089610; 20110114839; 20110136162; 20110166824; 20110169924; 20110259862; 20110291331; 20110293840; 20110295378; 20110297081; 20120041446; 20120065755; 20120100031; 20120132627; 20120132631; 20120138586; 20120156323; 20120191205; 20120191420; 20120193063; 20120193335; 20120195994; 20120201960; 20120205348; 20120209394; 20120219698; 20120232669; 20120232670; 20120232671; 20120237631; 20120243823; 20120255176; 20120279441; 20120298873; 20120298886; 20130001834; 20130004680; 20130008879; 20130031753; 20130045093; 20130056912; 20130064706; 20130079693; 20130101423; 20130101729; 20130101761; 20130108460; 20130112672; 20130134637; 20130136868; 20130140741; 20130147092; 20130166256; 20130168902; 20130186265; 20130186514; 20130193620; 20130197683; 20130199013; 20130209932; 20130211531; 20130233846; 20130263977; 20130268085; 20130270750; 20130280091; 20130291385; 20130295212; 20130344258; 20140014629; 20140021171; 20140034626; 20140035205; 20140035423; 20140035995; 20140037873; 20140039451; 20140039452; 20140039631; 20140039658; 20140050921; 20140052288; 20140061165; 20140061167; 20140061977; 20140079741; 20140095107; 20140099476; 20140104133; 20140109440; 20140113021; 20140120195; 20140136154; 20140140882; 20140145522; 20140154088; 20140163445; 20140163568; 20140172111; 20140174344; 20140182170; 20140184757; 20140189989; 20140190942; 20140194996; 20140216123; 20140217647; 20140222184; 20140228860; 20140231266; 20140246809; 20140249643; 20140252687; 20140263209; 20140265040; 20140265046; 20140265047; 20140265048; 20140265049; 20140271328; 20140271965; 20140286048; 20140291886; 20140294567; 20140295087; 20140306380; 20140314581; 20140319735; 20140319736; 20140319737; 20140319738; 20140322374; 20140328964; 20140336680; 20140361460; 20140363585; 20140368804; 20140370111; 20140370323; 20150001093; 20150017475; 20150021379; 20150021815; 20150024169; 20150024309; 20150024319; 20150027948; 20150029485; 20150030494; 20150032215; 20150034604; 20150037601; 20150041025; 20150044415; 20150045924; 20150045928; 20150048209; 20150050463; 20150054193; 20150054930; 20150054944; 20150054945; 20150060422; 20150064050; 20150069668; 20150080495; 20150089881; 20150090074; 20150093283; 20150100149; 20150102531; 20150104344; 20150104345; 20150108677; 20150113993; 20150125333; 20150125335; 20150129583; 20150130754; 20150132173; 20150135897; 20150136908; 20150139849; 20150140230; 20150141234; 20150145174; 20150145177; 20150147585; 20150158111; 20150161299; 20150165525; 20150165545; 20150165556; 20150167130; 20150174827; 20150183070; 20150184540; 20150196971; 20150197064; 20150197862; 20150198052; 20150202687; 20150202716; 20150202717; 20150209162; 20150209889; 20150210013; 20150217367; 20150219133; 20150219444; 20150219521; 20150224607; 20150224710; 20150227062; 20150227070; 20150231796; 20150231825; 20150231828; 20150231831; 20150239046; 20150246482; 20150246486; 20150247474; 20150251247; 20150251250; 20150251351; 20150251353; 20150252190; 20150258735; 20150259530; 20150259790; 20150266237; 20150266285; 20150270088; 20150273586; 20150273622; 20150273631; 20150275916; 20150283613; 20150283614; 20150283642; 20150283646; 20150283649; 20150285502; 20150285504; 20150290707; 20150290711; 20150290741; 20150290875; 20150300179; 20150306664; 20150306665; 20150306667; 20150306699; 20150306700; 20150314389; 20150320158; 20150321250; 20150321289; 20150322808; 20150328713; 20150328719; 20150336171; 20150343564; 20150343673; 20150351493; 20150352668; 20150352770; 20150360372; 20150367415; 20150367416; 20150367417; 20150367418; 20150367419; 20150367446; 20150367447; 20150367448; 20150367453; 20150367575; 20150367577; 20150371279; 20150374915; 20150374929; 20150374930; 20150375336; 20150375340; 20150376248; 20160001364; 20160001365; 20160001401; 20160001509; 20160008887; 20160008889; 20160008922; 20160009027; 20160009028; 20160009029; 20160009030; 20160009039; 20160010457; 20160010469; 20160014906; 20160022383; 20160023272; 20160023307; 20160024293; 20160030105; 20160032416; 20160038633; 20160039054; 20160039851; 20160045967; 20160045981; 20160047255; 20160052056; 20160052057; 20160052079; 20160052087; 20160052176; 20160052208; 20160054115; 20160054121; 20160054347; 20160059154; 20160059302; 20160059315; 20160059352; 20160059437; 20160061044; 20160061381; 20160066930; 20160067766; 20160067778; 20160067779; 20160067780; 20160067781; 20160067820; 20160067928; 20160069622; 20160074558; 20160074938; 20160074965; 20160075089; 20160082547; 20160082550; 20160082657; 20160082658; 20160082695; 20160083516; 20160089719; 20160089859; 20160090848; 20160096326; 20160098495; 20160101643; 20160107232; 20160107261; 20160107287; 20160107290; 20160107295; 20160114431; 20160114432; 20160114458; 20160115083; 20160120040; 20160121399; 20160121430; 20160122541; 20160129503; 20160129643; 20160131564; 20160135537; 20160136759; 20160136787; 20160136885; 20160136887; 20160136889; 20160136897; 20160137838; 20160137839; 20160143744; 20160144428; 20160144430; 20160144566; 20160145722; 20160146153; 20160151859; 20160151860; 20160151861; 20160158843; 20160158889; 20160160077; 20160166284; 20160167160; 20160167299; 20160167303; 20160167312; 20160168453; 20160168715; 20160172655; 20160175787; 20160175929; 20160175932; 20160175934; 20160175935; 20160181217; 20160184891; 20160184925; 20160184931; 20160186620; 20160187166; 20160193695; 20160193696; 20160193697; 20160193790; 20160199933; 20160200045; 20160200046; 20160200047; 20160201155; 20160202042; 20160202043; 20160202101; 20160207109; 20160207112; 20160211116; 20160211119; 20160214173; 20160214211; 20160221114; 20160221115; 20160221122; 20160221262; 20160222807; 20160223041; 20160228255; 20160228929; 20160228975; 20160228987; 20160228990; 20160228991; 20160228992; 20160229005; 20160235929; 20160236299; 20160237827; 20160242853; 20160242931; 20160243620; 20160243644; 20160243649; 20160243652; 20160244625; 20160244980; 20160247665; 20160250688; 20160250711; 20160250715; 20160250717; 20160250724; 20160256925; 20160260261; 20160263704; 20160265362; 20160265366; 20160271732; 20160271870; 20160271875; 20160271877; 20160271878; 20160271879; 20160271884; 20160273074; 20160273079; 20160273368; 20160273369; 20160273687; 20160276056; 20160279703; 20160279706; 20160279707; 20160279708; 20160279734; 20160279735; 20160282848; 20160288200; 20160288209; 20160288244; 20160288254; 20160288264; 20160288265; 20160288266; 20160288414; 20160297006; 20160297007; 20160297104; 20160297141; 20160297148; 20160298218; 20160298220; 20160298268; 20160303656; 20160303687; 20160303762; 20160303798; 20160305256; 20160305271; 20160307678; 20160307731; 20160310077; 20160310236; 20160310279; 20160310282; 20160311020; 20160311022; 20160311160; 20160311162; 20160311165; 20160311230; 20160312338; 20160312653; 20160313306; 20160317312; 20160318072; 20160318128; 20160318129; 20160318130; 20160318253; 20160319677; 20160319678; 20160321384; 20160324581; 20160325355; 20160325358; 20160325378; 20160325383; 20160325492; 20160325498; 20160325541; 20160326613; 20160326880; 20160332229; 20160332250; 20160332253; 20160332259; 20160332266; 20160332366; 20160332371; 20160332379; 20160332380; 20160332384; 20160339516; 20160339518; 20160339520; 20160339521; 20160339536; 20160339542; 20160339639; 20160339642; 20160339646; 20160346998; 20160348203; 20160348517; 20160354064; 20160354839; 20160354842; 20160354843; 20160355904; 20160358795; 20160361765; 20160361872; 20160361873; 20160367264; 20160368050; 20160368055; 20160368056; 20160368057; 20160368213; 20160369040; 20160369096; 20160375676; 20160376453; 20160376674; 20160377994; 20160378004; 20160380634; 20170001253; 20170001258; 20170001263; 20170001374; 20170001377; 20170001379; 20170002978; 20170007359; 20170007360; 20170007362; 20170007363; 20170007366; 20170007367; 20170007386; 20170008080; 20170008084; 20170008085; 20170008086; 20170008123; 20170008126; 20170008236; 20170008333; 20170009584; 20170014169; 20170014235; 20170014903; 20170014909; 20170014937; 20170014950; 20170015452; 20170016093; 20170016094; 20170016781; 20170021420; 20170021452; 20170021453; 20170021454; 20170021455; 20170021456; 20170021562; 20170021565; 20170021572; 20170027624; 20170028472; 20170028475; 20170028589; 20170028622; 20170028631; 20170028703; 20170030399; 20170033068; 20170036238; 20170036272; 20170036300; 20170036783; 20170037674; 20170037867; 20170038047; 20170043395; 20170043402; 20170044416; 20170050198; 20170050241; 20170050242; 20170050254; 20170050261; 20170050268; 20170050270; 20170050271; 20170051386; 20170051613; 20170051675; 20170056179; 20170057013; 20170059529; 20170066051; 20170066052; 20170066187; 20170067154; 20170067344; 20170067788; 20170068774; 20170069817; 20170072465; 20170072466; 20170072468; 20170072635; 20170074285; 20170080641; 20170087635; 20170087661; 20170087666; 20170087670; 20170087765; 20170088918; 20170092400; 20170092565; 20170095882; 20170095888; 20170100209; 20170100210; 20170100214; 20170100215; 20170100817; 20170100888; 20170100891; 20170100893; 20170100899; 20170101707; 20170106432; 20170106438; 20170106443; 20170106444; 20170106445; 20170106446; 20170106474; 20170106477; 20170106570; 20170106593; 20170107385; 20170107764; 20170107821; 20170113303; 20170113416; 20170114233; 20170115594; 20170119531; 20170120326; 20170120332; 20170120333; 20170120334; 20170120335; 20170120336; 20170120337; 20170120359; 20170120370; 20170120376; 20170120377; 20170120385; 20170120386; 20170120387; 20170120393; 20170120416; 20170120518; 20170120519; 20170120529; 20170120530; 20170120537; 20170120538; 20170122322; 20170123222; 20170123237; 20170125908; 20170125909; 20170125910; 20170126087; 20170128174; 20170128961; 20170129049; 20170129052; 20170129060; 20170129168; 20170129180; 20170129184; 20170129185; 20170130591; 20170130599; 20170136540; 20170136541; 20170136542; 20170136543; 20170136545; 20170136574; 20170136578; 20170136603; 20170136699; 20170136708; 20170137327; 20170143315; 20170144219; 20170144223; 20170144224; 20170144248; 20170144250; 20170144254; 20170145578; 20170145584; 20170145586; 20170151631; 20170151718; 20170151719; 20170154713; 20170155309; 20170157850; 20170159447; 20170164700; 20170165532; 20170165751; 20170165752; 20170165753; 20170165754; 20170165781; 20170165790; 20170165791; 20170165792; 20170165916; 20170167000; 20170167270; 20170167274; 20170173628; 20170173681; 20170173683; 20170173688; 20170173691; 20170173692; 20170173693; 20170173694; 20170173695; 20170173696; 20170173697; 20170173735; 20170173736; 20170173737; 20170173747; 20170173868; 20170173872; 20170173874; 20170173877; 20170173878; 20170173879; 20170173883; 20170173892; 20170175756; 20170181291; 20170182556; 20170182558; 20170182560; 20170182594; 20170182596; 20170182598; 20170183497; 20170183870; 20170186143; 20170189553; 20170189961; 20170189962; 20170189963; 20170189964; 20170189965; 20170191177; 20170197246; 20170197278; 20170197330; 20170197359; 20170203355; 20170203363; 20170203364; 20170203365; 20170203387; 20170203391; 20170203406; 20170203408; 20170203517; 20170209908; 20170209923; 20170209929; 20170209931; 20170209954; 20170209958; 20170209963; 20170210070; 20170210144; 20170211331; 20170216916; 20170216921; 20170216966; 20170217093; 20170217095; 20170217105; 20170217181; 20170218228; 20170219855; 20170220031; 20170225227; 20170225228; 20170225229; 20170225393; 20170225394; 20170225398; 20170226362; 20170231783; 20170232511; 20170232513; 20170232514; 20170232515; 20170232518; 20170232519; 20170232549; 20170232552; 20170232557; 20170232637; 20170232674; 20170233574; 20170234138; 20170239718; 20170239719; 20170239720; 20170239721; 20170239722; 20170239723; 20170239724; 20170239725; 20170239752; 20170239887; 20170239891; 20170239892; 20170241830; 20170242424; 20170246682; 20170246689; 20170246709; 20170246804; 20170247785; 20170248319; 20170249440; 20170252787; 20170252806; 20170252812; 20170252813; 20170252814; 20170252815; 20170252816; 20170252817; 20170252818; 20170252819; 20170252820; 20170252846; 20170252851; 20170252854; 20170252860; 20170252967; 20170252978; 20170259502; 20170260865; 20170266759; 20170266879; 20170271837; 20170274454; 20170274456; 20170276023; 20170282246; 20170282247; 20170282296; 20170282297; 20170282455; 20170284676; 20170291077; 20170291260; 20170291261; 20170291263; 20170291362; 20170292174; 20170292195; 20170294288; 20170294291; 20170297097; 20170297098; 20170297099; 20170297100; 20170297101; 20170297102; 20170297103; 20170297104; 20170297106; 20170297108; 20170297109; 20170297111; 20170297267; 20170297275; 20170297674; 20170299181; 20170299973; 20170304894; 20170304895; 20170304896; 20170304897; 20170304900; 20170304944; 20170304945; 20170304946; 20170304947; 20170306221; 20170306447; 20170306448; 20170306449; 20170306450; 20170306457; 20170306458; 20170306459; 20170306460; 20170306766; 20170307859; 20170312821; 20170312822; 20170312826; 20170312857; 20170312858; 20170312984; 20170312985; 20170314109; 20170314114; 20170315538; 20170320162; 20170320168; 20170320264; 20170320277; 20170322487; 20170323627; 20170326668; 20170326681; 20170326690; 20170326788; 20170326797; 20170326805; 20170326816; 20170332733; 20170333994; 20170333995; 20170334023; 20170334024; 20170334133; 20170334136; 20170334725; 20170335436; 20170338392; 20170341141; 20170341142; 20170341175; 20170341182; 20170341183; 20170342303; 20170342535; 20170348458; 20170348792; 20170348906; 20170348909; 20170350259; 20170354805; 20170354806; 20170355135; 20170355138; 20170355146; 20170355147; 20170356068; 20170360534; 20170361405; 20170368603; 20170368640; 20170368647; 20170368740; 20170368816; 20180000501; 20180000502; 20180000503; 20180000571; 20180001423; 20180001424; 20180001547; 20180001553; 20180001556; 20180001557; 20180001567; 20180009007; 20180009054; 20180009064; 20180009134; 20180010001; 20180010221; 20180010237; 20180014844; 20180015564; 20180015565; 20180015566; 20180021473; 20180021877; 20180021878; 20180022022; 20180022065; 20180027615; 20180027616; 20180029124; 20180029125; 20180029241; 20180029294; 20180029295; 20180029306; 20180031028; 20180036939; 20180036945; 20180036953; 20180038167; 20180042718; 20180043455; 20180043467; 20180044523; 20180050390; 20180050423; 20180050490; 20180050493; 20180050495; 20180052087; 20180055641; 20180056389; 20180056390; 20180056391; 20180056392; 20180056396; 20180056446; 20180057142; 20180061279; 20180065144; 20180065178; 20180065181; 20180065182; 20180065186; 20180065208; 20180065209; 20180065295; 20180065298; 20180065300; 20180065304; 20180065305; 20180065306; 20180065307; 20180065308; 20180065309; 20180065316; 20180065317; 20180065318; 20180065320; 20180065322; 20180066358; 20180066603; 20180067464; 20180071819; 20180071821; 20180071825; 20180071949; 20180071986; 20180071988; 20180071989; 20180072040; 20180072630; 20180078936; 20180079003; 20180079029; 20180079033; 20180079034; 20180079125; 20180085605; 20180085826; 20180085856; 20180086004; 20180087157; 20180088462; 20180089824; 20180093325; 20180093347; 20180093418; 20180093419; 20180094953; 20180095450; 20180096175; 20180098919; 20180099331; 20180104770; 20180105903; 20180111191; 20180111193; 20180111194; 20180111195; 20180111196; 20180111197; 20180111198; 20180111219; 20180111317; 20180111318; 20180111319; 20180111334; 20180113445; 20180115072; 20180116762; 20180117674; 20180117675; 20180117713; 20180117845; 20180122541; 20180124341; 20180125365; 20180126460; 20180126461; 20180126462; 20180126487; 20180126637; 20180126638; 20180126639; 20180126640; 20180126641; 20180126642; 20180126648; 20180126649; 20180126650; 20180126655; 20180126666; 20180126720; 20180127317; 20180128803; 20180133583; 20180133801; 20180133804; 20180133839; 20180133840; 20180133956; 20180133958; 20180134027; 20180136458; 20180141119; 20180141123; 20180141126; 20180141127; 20180141159; 20180141160; 20180141162; 20180141174; 20180141235; 20180141274; 20180141305; 20180143147; 20180144934; 20180147627; 20180147628; 20180147653; 20180147654; 20180147655; 20180147669; 20180147779; 20180148378; 20180148379; 20180148380; 20180148585; 20180149039; 20180151048; 20180153205; 20180154437; 20180154438; 20180154439; 20180154440; 20180154441; 20180154442; 20180154443; 20180154444; 20180154484; 20180154574; 20180154580; 20180154591; 20180154657; 20180159016; 20180161873; 20180161874; 20180161875; 20180161932; 20180161934; 20180161935; 20180161954; 20180162013; 20180162044; 20180162047; 20180162048; 20180162053; 20180163311; 20180166251; 20180166665; 20180168254; 20180168294; 20180169351; 20180169756; 20180169784; 20180169950; 20180169951; 20180169952; 20180169960; 20180169970; 20180170107; 20180172369; 20180178284; 20180178285; 20180178286; 20180178287; 20180178288; 20180178325; 20180178326; 20180178413; 20180178491; 20180179332; 20180179956; 20180180803; 20180180812; 20180180813; 20180180874; 20180180896; 20180185098; 20180185893; 20180185921; 20180185961; 20180185965; 20180186067; 20180186078; 20180186080; 20180186081; 20180186082; 20180187569; 20180193916; 20180193923; 20180193953; 20180193954; 20180193955; 20180194080; 20180195186; 20180195684; 20180200790; 20180200791; 20180200792; 20180200793; 20180200794; 20180200796; 20180200797; 20180200798; 20180200800; 20180200836; 20180200960; 20180202076; 20180202293; 20180207725; 20180207749; 20180207750; 20180207850; 20180207862; 20180207863; 20180207865; 20180207866; 20180207868; 20180208762; 20180208785; 20180209381; 20180209498; 20180214874; 20180214946; 20180214947; 20180214950; 20180214951; 20180214955; 20180214984; 20180214985; 20180215094; 20180215103; 20180216501; 20180221950; 20180226917; 20180228570; 20180228612; 20180228613; 20180228737; 20180229300; 20180229434; 20180229436; 20180236546; 20180236551; 20180237325; 20180237329; 20180240691; 20180243094; 20180243097; 20180243977; 20180243991; 20180244862; 20180244863; 20180250737; 20180250739; 20180250744; 20180250745; 20180250746; 20180250771; 20180250772; 20180250773; 20180250774; 20180250775; 20180250890; 20180251645; 20180252398; 20180257138; 20180257297; 20180264679; 20180264719; 20180265417; 20180265738; 20180272464; 20180272610; 20180272652; 20180273707; 20180281236; 20180281237; 20180281282; 20180281283; 20180281284; 20180281294; 20180289493; 20180290212; 20180290373; 20180296343; 20180297113; 20180297114; 20180297117; 20180297272; 20180297296; 20180303491; 20180303616; 20180304353; 20180304359; 20180304360; 20180304361; 20180304363; 20180304364; 20180304365; 20180304369; 20180304370; 20180304537; 20180304540; 20180305266; 20180307209; 20180309202; 20180311731; 20180311735; 20180311738; 20180318657; 20180318922; 20180318925; 20180318928; 20180318932; 20180318933; 20180319108; 20180319150; 20180320006; 20180323514; 20180326488; 20180326663; 20180326664; 20180326665; 20180326668; 20180333911; 20180333912; 20180333913; 20180337110; 20180338196; 20180345367; 20180345382; 20180345405; 20180345575; 20180345576; 20180354304; 20180354860; 20180355199; 20180360609; 20180361510; 20180361660; 20180361661; 20180361666; 20180361674; 20180369918; 20180370114; 20180370120; 20180370125; 20180370147; 20180370846; 20180370860; 20180371244; 20180374262; 20190000166; 20190001412; 20190001553; 20190001563; 20190001564; 20190001570; 20190001576; 20190002353; 20190009472; 20190010270; 20190017185; 20190020105; 20190022427; 20190022428; 20190022725; 20190022926; 20190026499; 20190030601; 20190030602; 20190030605; 20190030809; 20190030810; 20190030811; 20190031908; 20190031911; 20190033719; 20190033737; 20190039182; 20190039294; 20190039367; 20190047047; 20190047212; 20190047214; and 20190047277.

See, U.S. Pat. Nos. RE41584; RE43661; RE44817; RE44820; RE46275; U.S. Pat. Nos. 4,026,677; 4,034,454; 4,034,906; 4,065,302; 4,171,339; 4,173,614; 4,234,661; 4,241,135; 4,358,506; 4,380,574; 4,396,677; 4,459,062; 4,510,171; 4,518,468; 4,553,856; 4,640,816; 4,683,019; 4,699,310; 4,714,624; 4,725,509; 4,818,628; 4,861,751; 4,873,152; 4,880,614; 4,888,127; 4,911,987; 4,916,022; 4,956,011; 4,985,313; 5,015,502; 5,034,274; 5,039,990; 5,047,386; 5,071,828; 5,087,515; 5,099,759; 5,104,849; 5,132,278; 5,135,817; 5,154,425; 5,188,164; 5,194,161; 5,204,302; 5,209,987; 5,224,969; 5,234,715; 5,247,986; 5,255,730; 5,262,202; 5,266,357; 5,270,296; 5,289,967; 5,326,525; 5,328,717; 5,338,598; 5,342,812; 5,350,637; 5,352,519; 5,362,523; 5,366,570; 5,378,500; 5,422,209; 5,429,843; 5,434,027; 5,458,480; 5,458,705; 5,476,725; 5,490,911; 5,498,298; 5,503,703; 5,516,725; 5,526,914; 5,538,674; 5,580,403; 5,620,791; 5,624,505; 5,628,945; 5,648,177; 5,669,436; 5,683,825; 5,686,178; 5,694,184; 5,709,958; 5,741,376; 5,747,111; 5,761,787; 5,770,273; 5,834,070; 5,837,960; 5,865,909; 5,873,771; 5,880,692; 5,939,201; 5,939,224; 5,948,541; 5,952,253; 5,964,020; 5,976,716; 5,989,728; 5,993,701; 5,993,979; 6,001,461; 6,017,628; 6,019,878; 6,054,185; 6,077,615; 6,086,959; 6,096,436; 6,117,533; 6,119,483; 6,128,918; 6,129,996; 6,159,267; 6,163,961; 6,187,700; 6,214,195; 6,232,037; 6,267,864; 6,277,169; 6,300,263; 6,300,389; 6,322,897; 6,355,338; 6,360,562; 6,372,346; 6,377,729; 6,423,387; 6,427,489; 6,430,965; 6,513,433; 6,526,778; 6,528,145; 6,531,704; 6,534,194; 6,537,648; 6,537,689; 6,540,800; 6,541,695; 6,551,760; 6,555,299; 6,558,841; 6,566,035; 6,589,311; 6,593,061; 6,596,150; 6,607,844; 6,612,478; 6,613,697; 6,620,861; 6,635,357; 6,643,442; 6,663,982; 6,669,774; 6,669,989; 6,673,387; 6,676,728; 6,682,780; 6,689,186; 6,699,304; 6,713,519; 6,723,279; 6,730,410; 6,740,464; 6,749,101; 6,750,023; 6,765,151; 6,771,009; 6,779,951; 6,780,305; 6,797,313; 6,797,449; 6,800,400; 6,800,417; 6,800,574; 6,806,478; 6,824,689; 6,828,507; 6,845,635; 6,847,699; 6,852,010; 6,858,374; 6,866,929; 6,871,514; 6,875,949; 6,881,483; 6,893,732; 6,899,777; 6,909,173; 6,909,192; 6,913,184; 6,914,024; 6,929,865; 6,939,505; 6,974,070; 6,974,501; 6,979,646; 6,989,200; 7,004,994; 7,005,191; 7,008,969; 7,011,760; 7,022,165; 7,040,953; 7,052,241; 7,060,222; 7,076,959; 7,094,473; 7,097,938; 7,105,217; 7,122,279; 7,145,244; 7,157,188; 7,162,302; 7,169,478; 7,169,489; 7,172,663; 7,174,637; 7,192,673; 7,195,842; 7,235,330; 7,235,736; 7,241,416; 7,241,533; 7,259,032; 7,282,444; 7,285,337; 7,285,496; 7,287,960; 7,288,576; 7,299,749; 7,300,559; 7,309,548; 7,311,944; 7,312,168; 7,318,983; 7,321,012; 7,326,434; 7,338,741; 7,351,773; 7,354,471; 7,358,008; 7,361,239; 7,381,517; 7,384,680; 7,393,559; 7,405,326; 7,410,728; 7,413,109; 7,416,835; 7,420,065; 7,432,014; 7,438,990; 7,451,906; 7,455,458; 7,459,233; 7,476,469; 7,514,174; 7,521,567; 7,521,928; 7,560,138; 7,575,039; 7,597,769; 7,604,897; 7,608,178; 7,621,976; 7,622,424; 7,625,668; 7,626,665; 7,629,058; 7,629,480; 7,631,518; 7,635,617; 7,642,468; 7,645,543; 7,666,233; 7,666,568; 7,674,555; 7,678,668; 7,691,279; 7,722,731; 7,726,872; 7,727,846; 7,736,542; 7,736,794; 7,745,050; 7,759,007; 7,771,547; 7,781,376; 7,782,433; 7,794,881; 7,820,332; 7,825,007; 7,838,130; 7,838,170; 7,851,804; 7,858,205; 7,867,907; 7,896,222; 7,939,126; 7,940,361; 7,964,262; 7,976,985; 7,977,405; 7,989,068; 7,997,472; 8,007,178; 8,007,557; 8,007,929; 8,017,263; 8,025,983; 8,025,984; 8,048,571; 8,063,489; 8,066,946; 8,071,419; 8,079,141; 8,097,301; 8,097,303; 8,114,211; 8,119,267; 8,119,288; 8,119,314; 8,119,315; 8,137,525; 8,173,010; 8,173,269; 8,182,939; 8,182,943; 8,202,649; 8,216,439; 8,221,921; 8,236,452; 8,247,142; 8,273,194; 8,313,560; 8,319,350; 8,323,820; 8,334,075; 8,339,837; 8,353,574; 8,354,136; 8,357,311; 8,357,731; 8,361,873; 8,367,224; 8,372,685; 8,377,999; 8,389,060; 8,389,147; 8,394,495; 8,410,016; 8,414,424; 8,425,651; 8,428,671; 8,435,477; 8,436,130; 8,436,833; 8,440,498; 8,455,131; 8,455,331; 8,465,847; 8,466,095; 8,487,439; 8,497,312; 8,507,132; 8,512,808; 8,546,161; 8,552,088; 8,563,872; 8,568,684; 8,586,199; 8,586,492; 8,591,997; 8,592,057; 8,604,350; 8,610,120; 8,617,640; 8,617,994; 8,623,554; 8,628,987; 8,629,564; 8,632,850; 8,634,228; 8,636,194; 8,637,864; 8,652,686; 8,654,566; 8,658,304; 8,673,050; 8,673,477; 8,692,127; 8,697,322; 8,708,458; 8,723,176; 8,748,241; 8,759,473; 8,765,837; 8,766,253; 8,778,538; 8,783,063; 8,789,626; 8,789,998; 8,790,768; 8,790,793; 8,795,899; 8,796,683; 8,797,487; 8,802,286; 8,810,035; 8,815,974; 8,828,579; 8,829,528; 8,840,831; 8,842,358; 8,844,782; 8,852,801; 8,853,867; 8,860,021; 8,882,442; 8,883,314; 8,884,284; 8,893,954; 8,901,558; 8,906,462; 8,906,469; 8,907,871; 8,907,879; 8,916,406; 8,916,424; 8,919,150; 8,921,473; 8,926,389; 8,932,060; 8,932,184; 8,932,771; 8,946,704; 8,951,650; 8,952,380; 8,956,478; 8,956,766; 8,956,912; 8,957,468; 8,960,523; 8,962,188; 8,963,148; 8,969,867; 8,974,105; 8,976,997; 8,979,606; 8,980,115; 8,983,098; 8,986,880; 8,987,728; 8,988,116; 8,994,695; 8,999,200; 9,005,821; 9,006,733; 9,011,620; 9,034,442; 9,035,867; 9,040,975; 9,040,981; 9,045,335; 9,048,665; 9,054,364; 9,070,399; 9,070,729; 9,076,825; 9,078,294; 9,079,246; 9,082,861; 9,083,054; 9,090,955; 9,093,383; 9,097,995; 9,101,978; 9,102,007; 9,102,566; 9,105,869; 9,109,429; 9,112,086; 9,112,168; 9,113,571; 9,117,662; 9,127,515; 9,130,358; 9,136,568; 9,142,679; 9,142,681; 9,145,363; 9,153,436; 9,166,019; 9,166,061; 9,168,573; 9,171,787; 9,175,174; 9,176,571; 9,181,790; 9,184,160; 9,184,355; 9,186,295; 9,190,529; 9,190,666; 9,198,829; 9,205,578; 9,209,480; 9,214,566; 9,218,966; 9,219,161; 9,220,328; 9,227,243; 9,231,410; 9,236,428; 9,236,606; 9,241,869; 9,243,475; 9,252,283; 9,252,286; 9,258,651; 9,260,390; 9,263,259; 9,264,090; 9,269,647; 9,272,946; 9,281,517; 9,284,212; 9,287,405; 9,287,521; 9,287,573; 9,287,916; 9,290,407; 9,296,190; 9,308,616; 9,318,484; 9,324,875; 9,330,909; 9,331,156; 9,331,251; 9,333,148; 9,339,993; 9,350,005; 9,351,083; 9,354,029; 9,359,513; 9,362,972; 9,369,553; 9,402,313; 9,406,698; 9,407,746; 9,408,781; 9,414,513; 9,419,299; 9,428,826; 9,431,430; 9,434,633; 9,435,915; 9,437,744; 9,440,853; 9,446,979; 9,466,725; 9,468,317; 9,471,172; 9,472,310; 9,472,656; 9,474,688; 9,474,689; 9,475,947; 9,476,685; 9,477,346; 9,478,422; 9,482,105; 9,488,456; 9,490,350; 9,490,351; 9,494,829; 9,496,375; 9,505,648; 9,508,979; 9,511,005; 9,512,029; 9,522,836; 9,530,895; 9,536,844; 9,545,017; 9,556,505; 9,559,213; 9,564,457; 9,564,589; 9,564,938; 9,565,910; 9,575,037; 9,587,296; 9,593,924; 9,599,766; 9,601,779; 9,603,775; 9,603,780; 9,608,124; 9,608,228; 9,611,167; 9,614,062; 9,614,100; 9,614,160; 9,625,764; 9,643,250; 9,643,279; 9,655,293; 9,656,877; 9,660,265; 9,661,423; 9,663,400; 9,666,896; 9,668,944; 9,676,653; 9,682,019; 9,682,425; 9,688,540; 9,700,485; 9,700,486; 9,705,099; 9,707,153; 9,707,154; 9,707,155; 9,713,572; 9,717,648; 9,717,649; 9,722,275; 9,724,727; 9,728,648; 9,728,773; 9,729,187; 9,731,377; 9,735,428; 9,742,001; 9,744,743; 9,745,223; 9,755,191; 9,765,167; 9,765,271; 9,765,635; 9,768,026; 9,769,573; 9,774,192; 9,780,348; 9,789,665; 9,790,124; 9,793,057; 9,812,467; 9,812,582; 9,815,144; 9,818,715; 9,826,652; 9,832,866; 9,833,838; 9,835,428; 9,839,579; 9,849,066; 9,850,160; 9,852,904; 9,857,860; 9,859,114; 9,862,617; 9,871,059; 9,871,176; 9,871,209; 9,881,744; 9,887,066; 9,899,136; 9,899,672; 9,903,037; 9,905,516; 9,905,860; 9,908,803; 9,911,874; 9,915,756; 9,916,958; 9,917,263; 9,919,472; 9,923,000; 9,923,166; 9,931,817; 9,932,663; 9,933,820; 9,938,839; 9,943,927; 9,943,929; 9,947,964; 9,954,212; 9,960,122; 9,972,802; 9,990,965; 9,991,221; 9,991,293; 9,991,395; 9,991,453; 9,993,395; 9,997,545; 9,997,784; 9,999,576; 10,002,685; 10,008,870; 10,023,495; 10,051,753; 10,065,885; 10,082,605; 10,116,777; 10,117,806; 10,117,810; 10,123,947; 10,134,766; 10,135,002; 10,137,667; 10,162,084; 10,166,744; 10,170,500; 10,170,726; 10,172,695; 10,173,916; 10,181,017; 10,195,643; 10,196,295; 10,202,216; 20010000889; 20010018159; 20010021292; 20010028990; 20010038029; 20010039810; 20010043996; 20020007751; 20020009626; 20020025493; 20020031731; 20020041137; 20020056401; 20020062858; 20020066233; 20020069592; 20020081447; 20020082171; 20020084527; 20020090821; 20020092325; 20020098381; 20020098776; 20020108400; 20020110698; 20020144838; 20020153253; 20020154741; 20020160308; 20020160685; 20020168051; 20020173416; 20020177003; 20020192494; 20020192564; 20020195676; 20030003474; 20030009126; 20030019326; 20030022094; 20030029910; 20030039459; 20030044593; 20030068575; 20030070916; 20030108795; 20030109202; 20030113506; 20030116503; 20030119920; 20030127051; 20030128428; 20030161750; 20030162127; 20030173720; 20030180571; 20030189082; 20030203205; 20040009402; 20040016769; 20040016912; 20040018432; 20040023087; 20040035910; 20040071882; 20040081895; 20040096742; 20040100164; 20040106060; 20040112478; 20040147620; 20040149806; 20040154488; 20040161789; 20040168637; 20040182835; 20040192063; 20040192171; 20040197650; 20040202883; 20040206267; 20040209756; 20040210289; 20040219295; 20040221515; 20040224258; 20040231758; 20040234866; 20040234883; 20040242792; 20040247782; 20040249428; 20040254419; 20040261420; 20040265736; 20050007105; 20050008939; 20050013759; 20050023508; 20050025797; 20050031891; 20050036893; 20050036898; 20050040090; 20050044987; 20050045034; 20050048571; 20050054510; 20050056806; 20050061107; 20050064291; 20050065035; 20050069640; 20050079132; 20050089627; 20050095442; 20050098609; 20050100790; 20050106495; 20050107870; 20050118482; 20050119725; 20050127334; 20050142377; 20050147752; 20050149002; 20050149169; 20050151228; 20050153161; 20050153208; 20050155779; 20050165471; 20050172643; 20050175822; 20050182482; 20050202343; 20050216075; 20050227148; 20050230029; 20050233886; 20050240100; 20050244337; 20050255694; 20050261763; 20050278020; 20060001726; 20060021221; 20060027625; 20060035149; 20060051600; 20060062684; 20060094603; 20060102871; 20060108567; 20060118758; 20060119249; 20060135344; 20060141362; 20060142853; 20060147138; 20060147369; 20060147631; 20060151582; 20060160919; 20060167120; 20060172073; 20060216539; 20060216604; 20060224027; 20060225817; 20060226421; 20060227695; 20060228475; 20060234127; 20060235060; 20060246725; 20060249705; 20060274510; 20060276875; 20060280998; 20070000129; 20070002239; 20070010702; 20070029927; 20070048531; 20070054189; 20070061006; 20070065675; 20070068605; 20070072113; 20070093006; 20070099088; 20070104605; 20070111893; 20070122549; 20070122707; 20070122710; 20070128520; 20070128521; 20070140065; 20070141469; 20070152026; 20070158200; 20070160315; 20070178384; 20070187464; 20070189986; 20070214467; 20070227627; 20070251389; 20070259220; 20070298325; 20070298351; 20080015284; 20080015494; 20080026220; 20080032192; 20080041921; 20080047599; 20080057203; 20080057267; 20080057395; 20080057616; 20080075878; 20080075984; 20080087629; 20080106261; 20080110491; 20080139342; 20080145707; 20080152998; 20080156475; 20080175982; 20080188373; 20080233434; 20080241660; 20080241705; 20080268618; 20080280201; 20080280424; 20080284719; 20080284768; 20080290329; 20080290795; 20080299459; 20080302418; 20080306182; 20080308792; 20090000480; 20090004764; 20090004878; 20090011575; 20090014055; 20090043116; 20090046441; 20090075083; 20090076189; 20090098674; 20090110954; 20090114797; 20090117466; 20090117707; 20090123690; 20090131203; 20090136769; 20090155676; 20090160325; 20090178741; 20090214373; 20090214857; 20090235915; 20090267491; 20090269497; 20090269605; 20090284138; 20090288952; 20090291312; 20090291345; 20090297718; 20090311598; 20090317658; 20100013096; 20100015330; 20100021565; 20100029036; 20100036075; 20100048762; 20100056026; 20100062179; 20100078830; 20100089976; 20100089977; 20100102446; 20100112192; 20100119846; 20100126132; 20100130682; 20100132765; 20100133688; 20100139840; 20100178571; 20100190038; 20100190054; 20100196750; 20100203706; 20100209328; 20100216034; 20100216907; 20100224867; 20100227071; 20100227157; 20100228025; 20100229940; 20100236288; 20100255362; 20100261144; 20100267856; 20100279000; 20100285207; 20100291758; 20100300532; 20100310941; 20100313416; 20100314258; 20100315796; 20100326429; 20100330357; 20110003143; 20110003200; 20110006670; 20110008640; 20110015102; 20110027547; 20110032467; 20110052921; 20110065973; 20110104571; 20110108760; 20110111303; 20110114075; 20110114182; 20110139251; 20110143201; 20110165462; 20110195279; 20110214799; 20110240108; 20110240594; 20110245083; 20110248251; 20110253990; 20110269621; 20110278051; 20110290549; 20110293976; 20110297450; 20110305578; 20120009339; 20120012032; 20120024332; 20120028176; 20120032329; 20120040282; 20120040283; 20120044652; 20120045688; 20120051116; 20120052625; 20120056647; 20120061665; 20120061677; 20120062813; 20120063203; 20120064650; 20120067728; 20120085811; 20120113341; 20120114518; 20120115973; 20120128284; 20120129056; 20120135153; 20120146014; 20120164413; 20120171847; 20120194756; 20120196952; 20120207264; 20120208002; 20120214900; 20120231352; 20120232308; 20120238658; 20120241734; 20120244060; 20120261654; 20120264884; 20120270106; 20120296029; 20120316716; 20120322197; 20120326601; 20120328945; 20130002764; 20130008698; 20130017141; 20130017390; 20130025409; 20130026636; 20130028781; 20130029886; 20130034759; 20130034932; 20130036942; 20130043573; 20130054061; 20130061636; 20130062107; 20130068513; 20130071294; 20130075735; 20130092924; 20130092925; 20130092944; 20130101596; 20130105791; 20130109194; 20130119360; 20130119373; 20130119374; 20130126868; 20130134414; 20130137033; 20130140554; 20130149632; 20130153889; 20130155790; 20130161606; 20130161608; 20130161609; 20130161621; 20130162306; 20130168257; 20130172642; 20130181214; 20130184415; 20130187151; 20130192304; 20130193433; 20130193493; 20130196094; 20130196095; 20130196096; 20130196097; 20130196468; 20130199241; 20130200365; 20130200375; 20130202823; 20130203214; 20130209698; 20130210618; 20130213848; 20130216597; 20130216742; 20130219890; 20130232366; 20130233303; 20130236662; 20130241069; 20130248528; 20130260217; 20130266915; 20130274373; 20130289216; 20130300284; 20130305727; 20130309946; 20130313708; 20130338252; 20130343023; 20130344765; 20140001155; 20140008327; 20140008686; 20140013554; 20140025978; 20140034544; 20140037969; 20140039087; 20140039088; 20140047996; 20140051335; 20140063432; 20140065361; 20140065430; 20140091299; 20140103338; 20140103340; 20140103346; 20140106504; 20140110153; 20140110706; 20140120417; 20140127868; 20140130736; 20140131700; 20140131702; 20140134325; 20140140030; 20140141303; 20140151320; 20140151321; 20140151370; 20140151371; 20140151691; 20140154646; 20140162043; 20140175435; 20140177132; 20140203277; 20140204160; 20140209886; 20140209898; 20140227548; 20140228474; 20140231126; 20140231799; 20140231803; 20140252351; 20140255785; 20140264323; 20140265812; 20140272154; 20140272398; 20140335653; 20140338552; 20140338894; 20140339122; 20140339125; 20140339126; 20140339555; 20140341883; 20140341888; 20140341889; 20140341890; 20140341891; 20140341945; 20140342979; 20140346216; 20140349191; 20140353808; 20140366761; 20140370337; 20140370654; 20140373743; 20140374084; 20140374728; 20150001516; 20150021603; 20150030932; 20150041788; 20150064374; 20150064474; 20150064841; 20150069449; 20150071913; 20150076469; 20150079298; 20150093589; 20150093880; 20150094396; 20150103495; 20150108694; 20150116968; 20150118570; 20150123091; 20150126641; 20150129544; 20150132548; 20150132563; 20150137122; 20150140731; 20150147540; 20150155312; 20150155392; 20150155399; 20150155456; 20150179777; 20150179804; 20150179998; 20150182315; 20150207080; 20150207146; 20150214342; 20150214555; 20150228801; 20150231040; 20150243792; 20150259263; 20150270531; 20150283642; 20150298263; 20150299035; 20150311452; 20150314390; 20150315392; 20150333160; 20150338709; 20150340641; 20150348863; 20150349154; 20150357581; 20150360954; 20150366756; 20150371854; 20150372123; 20150374582; 20150380364; 20150380529; 20160003063; 20160005878; 20160013439; 20160018371; 20160023438; 20160023948; 20160024676; 20160033248; 20160040312; 20160043384; 20160043392; 20160043429; 20160056392; 20160056396; 20160061806; 20160064422; 20160064669; 20160071625; 20160075119; 20160079548; 20160083135; 20160093642; 20160095795; 20160095796; 20160099353; 20160101433; 20160101988; 20160104877; 20160107262; 20160126360; 20160141422; 20160145990; 20160151854; 20160151856; 20160153271; 20160153272; 20160159955; 20160163744; 20160163948; 20160164046; 20160181601; 20160186579; 20160190329; 20160190640; 20160204271; 20160207106; 20160218106; 20160221733; 20160233474; 20160233487; 20160240690; 20160244212; 20160248115; 20160254097; 20160254511; 20160254687; 20160258383; 20160260948; 20160264479; 20160289483; 20160301071; 20160326892; 20160336538; 20160340256; 20160340768; 20160349029; 20160351321; 20160355433; 20160358575; 20160359050; 20160370898; 20160381794; 20170001919; 20170005048; 20170005361; 20170014312; 20170016703; 20170021383; 20170022608; 20170023168; 20170025440; 20170028682; 20170029300; 20170030204; 20170031057; 20170033129; 20170036303; 20170036951; 20170047583; 20170050349; 20170053584; 20170066928; 20170072104; 20170090462; 20170101875; 20170103714; 20170107636; 20170108780; 20170110728; 20170110760; 20170129806; 20170135909; 20170138164; 20170139082; 20170148562; 20170162701; 20170162790; 20170166730; 20170174545; 20170174565; 20170179482; 20170183257; 20170189965; 20170194263; 20170194686; 20170197875; 20170210662; 20170211990; 20170212088; 20170216962; 20170227800; 20170229731; 20170231873; 20170231874; 20170233287; 20170235852; 20170243900; 20170252271; 20170252851; 20170253523; 20170266081; 20170271674; 20170278975; 20170285227; 20170288224; 20170290746; 20170296441; 20170296442; 20170304933; 20170309710; 20170317336; 20170320773; 20170330674; 20170333295; 20170338472; 20170341451; 20170348201; 20170348202; 20170349756; 20170355855; 20170358685; 20170358795; 20170362119; 20170362687; 20170365473; 20170365843; 20170365853; 20170368644; 20180006293; 20180019458; 20180022640; 20180026171; 20180037546; 20180038995; 20180040916; 20180047696; 20180052254; 20180070458; 20180071175; 20180072613; 20180073532; 20180083266; 20180083281; 20180083282; 20180083289; 20180086025; 20180088399; 20180099307; 20180102543; 20180122629; 20180131040; 20180136367; 20180149196; 20180161931; 20180162771; 20180170914; 20180175333; 20180183062; 20180185875; 20180186120; 20180202234; 20180209057; 20180212184; 20180212250; 20180214351; 20180215644; 20180219254; 20180221985; 20180228701; 20180237567; 20180264778; 20180267373; 20180273422; 20180273425; 20180282604; 20180291195; 20180312660; 20180319132; 20180335659; 20180353391; 20180363361; 20190019736; 20190022979; 20190030498; and 20190031844.
{1} S. N. Schiffres, A. Azizi, Additive manufacturing processes and additively manufactured products, U.S. Ser. No. 11/167,375B2, 2021. patents.google.com/patent/U.S. Ser. No. 11/167,375B2/en (accessed Dec. 10, 2021).
{2} S. N. Schiffres, A. Azizi, Additive manufacturing processes and additively manufactured products, US20200047288A1, 2020. patents.google.com/patent/US20200047288A1/en (accessed Apr. 29, 2020).
{3} A. Azizi, M. A. Daeumer, S. N. Schiffres, Additive laser metal deposition onto silicon, Additive Manufacturing. 25 (2019) 390-398. doi.org/10.1016/j.addma.2018.09.027.
{4} A. Azizi, X. Chen, F. Gou, F. Hejripour, J. Goodman, I.-T. Bae, S. Rangarajan, C. L. Arvin, B. G. Sammakia, C. Ke, G. Zhou, S. N. Schiffres, Selective Laser Melting of Metal onto Graphite, Under-Review. (2021) 1-18.
{5} A. Azizi, M. A. Daeumer, J. C. Simmons, B. G. Sammakia, B. T. Murray, S. N. Schiffres, Additive Laser Metal Deposition Onto Silicon for Enhanced Microelectronics Cooling, in: 2019 IEEE 69th Electronic Components and Technology Conference (ECTC), IEEE, Las Vegas, NV, USA, 2019: pp. 1970-1976. doi.org/10.1109/ECTC.2019.00302.
{6} Th. Schubert, B. Trindade, T. Weißgärber, B. Kieback, Interfacial design of Cu-based composites prepared by powder metallurgy for heat sink applications, Materials Science and Engineering: A. 475 (2008) 39-44. doi.org/10.1016/j.msea.2006.12.146.
{7} T. Schubert, L. Ciupiñski, W. Zieliński, A. Michalski, T. Weiβgärber, B. Kieback, Interfacial characterization of Cu/diamond composites prepared by powder metallurgy for heat sink applications, Scripta Materialia. 58 (2008) 263-266. doi.org/10.1016/j.scriptamat.2007.10.011.
{8} P. W. Ruch, O. Beffort, S. Kleiner, L. Weber, P. J. Uggowitzer, Selective interfacial bonding in Al(Si)-diamond composites and its effect on thermal conductivity, Composites Science and Technology. 66 (2006) 2677-2685. doi.org/10.1016/j.compscitech.2006.03.016.
{9} C. Monachon, L. Weber, Thermal boundary conductance between refractory metal carbides and diamond, Acta Materialia. 73 (2014) 337-346. doi.org/10.1016/j.actamat.2014.04.024.
{10} S. N. Schiffres, A. Azizi, C. Ke, B. Sammakia, F. Gou, Thermal-safe additive manufacturing for electronics, Disclosure ID: FY2022-05, n.d.
{11} M. J. Ellsworth, L. A. Campbell, R. E. Simons, M. K. Iyengar, R. R. Schmidt, R. C. Chu, The evolution of water cooling for IBM large server systems: Back to the future, in: 2008 11th Intersociety Conference on Thermal and Thermomechanical Phenomena in Electronic Systems, 2008: pp. 266-274. doi.org/10.1109/ITHERM.2008.4544279.
{12} A. Bar-Cohen, J. D. Albrecht, J. J. Maurer, Near-Junction Thermal Management for Wide Bandgap Devices, in: 2011 IEEE Compound Semiconductor Integrated Circuit Symposium (CSICS), 2011: pp. 1-5. doi.org/10.1109/CSICS.2011.6062454.
{13} M. Garven, J. P. Calame, Simulation and Optimization of Gate Temperatures in GaN-on-SiC Monolithic Microwave Integrated Circuits, IEEE Transactions on Components and Packaging Technologies. 32 (2009) 63-72. doi.org/10.1109/TCAPT.2008.2004586.
{14} Yoonjin Won, Jungwan Cho, D. Agonafer, M. Asheghi, K. E. Goodson, Fundamental Cooling Limits for High Power Density Gallium Nitride Electronics, IEEE Transactions on Components, Packaging and Manufacturing Technology. 5 (2015) 737-744. doi.org/10.1109/TCPMT.2015.2433132.
{15} B. Yang, P. Wang, A. Bar-Cohen, Thermoelectric mini-contact cooler for hot-spot removal in high power devices, in: 56th Electronic Components and Technology Conference 2006, 2006: p. 6 pp.-. doi.org/10.1109/ECTC.2006.1645775.
{16} T. Foulkes, J. Oh, P. Birbarah, J. Neely, N. Miljkovic, R. C. N. Pilawa-Podgurski, Active hot spot cooling of GaN transistors with electric field enhanced jumping droplet condensation, in: 2017 IEEE Applied Power Electronics Conference and Exposition (APEC), 2017: pp. 912-918. doi.org/10.1109/APEC.2017.7930805.
{17} S. Moghaddam, M. Rada, A. Shooshtari, M. Ohadi, Y. Joshi, Evaluation of analytical models for thermal analysis and design of electronic packages, Microelectronics Journal. 34 (2003) 223-230. doi.org/10.1016/S0026-2692(02)00192-1.
{18} A. Azizi, S. N. Schiffres, Laser Metal Additive Manufacturing on Graphite, in: Solid Freeform Fabrication Symposium, Austin, TX, 2018: pp. 1-10.
{19} A. Faghri, Heat Pipe Science And Technology, Global Digital Press, 1995.
{20} R. S. Hale, R. Ranjan, C. H. Hidrovo, Capillary flow through rectangular micropillar arrays, International Journal of Heat and Mass Transfer. 75 (2014) 710-717. doi.org/10.1016/j.ijheatmasstransfer.2014.04.016.
{21} R. S. Hale, V. Bahadur, Characterization of microfluidic operations underlying an electrowetting heat pipe, in: 2017 16th IEEE Intersociety Conference on Thermal and Thermomechanical Phenomena in Electronic Systems (ITherm), 2017: pp. 610-614. doi.org/10.1109/ITHERM.2017.7992543.
{22} A. Chatterjee, M. M. Derby, Y. Peles, M. K. Jensen, Enhancement of condensation heat transfer with patterned surfaces, International Journal of Heat and Mass Transfer. 71 (2014) 675-681. doi.org/10.1016/j.ijheatmasstransfer.2013.12.069.
{23} T. B. Peters, M. McCarthy, J. Allison, F. A. Dominguez-Espinosa, D. Jenicek, H. A. Kariya, W. L. Staats, J. G. Brisson, J. H. Lang, E. N. Wang, Design of an Integrated Loop Heat Pipe Air-Cooled Heat Exchanger for High Performance Electronics, IEEE Transactions on Components, Packaging and Manufacturing Technology. 2 (2012) 1637-1648. doi.org/10.1109/TCPMT.2012.2207902.
{24} M. Ghajar, J. Darabi, N. Crews, A hybrid CFD-mathematical model for simulation of a MEMS loop heat pipe for electronics cooling applications, Journal of Micromechanics and Microengineering. 15 (2005) 313-321. doi.org/10.1088/0960-1317/15/2/010.
{25} C. Oshman, Q. Li, L.-A. Liew, R. Yang, V. M. Bright, Y. C. Lee, Flat flexible polymer heat pipes, J. Micromech. Microeng. 23 (2013) 015001. doi.org/10.1088/0960-1317/23/1/015001.
{26} K. S. Udell, Heat transfer in porous media considering phase change and capillarity—the heat pipe effect, Int. J. Heat Mass Transfer. 28 (1985) 485-495. doi.org/I0.1016/0017-9310(85)90082-1.
{27} J. B. Boreyko, C.-H. Chen, Vapor chambers with jumping-drop liquid return from superhydrophobic condensers, International Journal of Heat and Mass Transfer. 61 (2013) 409-418. doi.org/10.1016/j.ijheatmasstransfer.2013.01.077.
{28} K. F. Wiedenheft, H. A. Guo, X. Qu, J. B. Boreyko, F. Liu, K. Zhang, F. Eid, A. Choudhury, Z. Li, C.-H. Chen, Hotspot cooling with jumping-drop vapor chambers, Applied Physics Letters. 110 (2017) 141601. doi.org/10.1063/1.4979477.
{29} J. L. Plawsky, Transport Phenomena Fundamentals, Third Edition, CRC Press, 2014.
{30} Q. N. Pham, B. Shao, Y. Kim, Y. Won, Hierarchical and Well-Ordered Porous Copper for Liquid Transport Properties Control, ACS Applied Materials & Interfaces. 10 (2018) 16015-16023. doi.org/10.1021/acsami.8b02665.
{31} N. Clegg, K. Kota, X. He, S. Ross, Achieving Ultra-Omniphilic Wettability on Copper Using a Facile, Scalable, Tuned Bulk Micromanufacturing Approach, J. Micro Nano-Manuf. 5 (2017) 031003-031003-7. doi.org/10.1115/1.4036446.
{32} D. Attinger, C. Frankiewicz, A. R. Betz, T. M. Schutzius, R. Ganguly, A. Das, C.-J. Kim, C. M. Megaridis, Surface engineering for phase change heat transfer: A review, MRS Energy & Sustainability. 1 (2014). doi.org/10.1557/mre.2014.9.
{33} S. Mueller, M. Hodes, A. Lyons, Capillary-Driven Evaporation-Enhanced Heat Sink, IEEE Transactions on Components, Packaging and Manufacturing Technology. 3 (2013) 1683-1692. doi.org/10.1109/TCPMT.2013.2253157.
{34} M. Lee, C. Park, Mechanical-capillary-driven two-phase loop: Numerical modeling and experimental validation, International Journal of Heat and Mass Transfer. 125 (2018) 972-982. doi.org/10.1016/j.ijheatmasstransfer.2018.04.144.
{35} M. M. Rahman, E. Oleeroglu, M. McCarthy, Role of Wickability on the Critical Heat Flux of Structured Superhydrophilic Surfaces, Langmuir. 30 (2014) 11225-11234. doi.org/10.1021/1a5030923.
{36} S. Y D, S. C. Maroo, Origin of Surface-Driven Passive Liquid Flows, Langmuir. 32 (2016) 8593-8597. doi.org/10.1021/acs.langmuir.6b02117.
(37) A. Zou, S. C. Maroo, Critical height of micro/nano structures for pool boiling heat transfer enhancement, Applied Physics Letters. 103 (2013) 221602. doi.org/10.1063/1.4833543.
{38} A. A. Ginnay, S. Sett, J. Oh, N. Miljkovic, Steady Method for the Analysis of Evaporation Dynamics, Langmuir. 33 (2017) 12007-12015. doi.org/10.1021/acs.langmuir.7b02821.
{39} A. Fazeli, M. Mortazavi, S. Moghaddam, Hierarchical biphilic micro/nanostructures for a new generation phase-change heat sink, Applied Thermal Engineering. 78 (2015) 380-386. doi.org/10.1016/j.applthermaleng.2014.12.073.
{40} Y. Li, M. A. Alibakhshi, Y. Zhao, C. Duan, Exploring Ultimate Water Capillary Evaporation in Nanoscale Conduits, Nano Lett. 17 (2017) 4813-4819. doi.org/10.1021/acs.nanolett.7b01620.
{41} M. Mehrvand, S. A. Putnam, Probing the Local Heat Transfer Coefficient of Water-Cooled Microchannels Using Time-Domain Thermoreflectance, Journal of Heat Transfer. 139 (2017) 112403. doi.org/10.1115/1.4036691.
{42} M. R. Haque, A. R. Betz, Heat Transfer Enhancement by Insertion of Vortex Generators in Electronic Chip Cooling: A Numerical Study, in: ASME, 2017: p. V001T05A001. doi.org/10.1115/ICNMM2017-5523.
{43} S. G. Kandlikar, Controlling bubble motion over heated surface through evaporation momentum force to enhance pool boiling heat transfer, Applied Physics Letters. 102 (2013) 051611. doi.org/10.1063/1.4791682.
{44} V. Sahu, Y. K. Joshi, A. G. Fedorov, J.-H. Bahk, X. Wang, A. Shakouri, Experimental Characterization of Hybrid Solid-State and Fluidic Cooling for Thermal Management of Localized Hotspots, IEEE Transactions on Components, Packaging and Manufacturing Technology. 5 (2015) 57-64. doi.org/10.1109/TCPMT.2014.2332516.
{45} R. W. Knight, D. J. Hall, J. S. Goodling, R. C. Jaeger, Heat sink optimization with application to microchannels, IEEE Transactions on Components, Hybrids, and Manufacturing Technology. 15 (1992) 832-842. doi.org/10.1109/33.180049.
{46} M. McCarthy, K. Gerasopoulos, S. C. Maroo, A. J. Hart, Materials, Fabrication, and Manufacturing of Micro/Nanostructured Surfaces for Phase-Change Heat Transfer Enhancement, Nanoscale and Microscale Thermophysical Engineering. 18 (2014) 288-310. doi.org/10.1080/15567265.2014.926436.
{47} B. D. Iverson, T. W. Davis, S. V. Garimella, M. T. North, S. S. Kang, Heat and Mass Transport in Heat Pipe Wick Structures, Journal of Thermophysics and Heat Transfer. 21 (2007) 392-404. doi.org/10.2514/1.25809.
{48} S. Bigham, S. Moghaddam, Microscale study of mechanisms of heat transfer during flow boiling in a microchannel, International Journal of Heat and Mass Transfer. 88 (2015) 111-121. doi.org/10.1016/j.ijheatmasstransfer.2015.04.034.
{49} S. Krishnan, D. Hernon, M. Hodes, J. Mullins, A. M. Lyons, Design of Complex Structured Monolithic Heat Sinks for Enhanced Air Cooling, IEEE Transactions on Components, Packaging and Manufacturing Technology. 2 (2012) 266-277. doi.org/10.1109/TCPMT.2011.2175448.
{50} A. S. Rattner, General Characterization of Jet Impingement Array Heat Sinks With Interspersed Fluid Extraction Ports for Uniform High-Flux Cooling, J. Heat Transfer. 139 (2017) 082201. doi.org/10.1115/1.4036090.
{51} B. M. Fronk, A. S. Rattner, High-Flux Thermal Management With Supercritical Fluids, J. Heat Transfer. 138 (2016) 124501-124501-4. doi.org/10.1115/1.4034053.
{52} L. Constantin, N. Kraiem, Z. Wu, B. Cui, J.-L. Battaglia, C. Gamier, J.-F. Silvain, Y. F. Lu, Manufacturing of complex diamond-based composite structures via laser powder-bed fusion, Additive Manufacturing. 40 (2021) 101927. doi.org/10.1016/j.addma.2021.101927.
{53} X. Fang, Z. Yang, S. Tan, L. Duan, Feasibility Study of Selective Laser Melting for Metal Matrix Diamond Tools, Crystals. 10 (2020) 596. doi.org/10.3390/cryst10070596.
{54} A. B. Spierings, C. Leinenbach, C. Kenel, K. Wegener, Processing of metal-diamond-composites using selective laser melting, Rapid Prototyping Journal. 21 (2015) 130-136. doi.org/10.1108/RPJ-11-2014-0156.
{55} B. Mukherjee, A. J. F. Boyle, On the Debye Characteristic Temperature of Diamond, Physica Status Solidi (b). 22 (1967) K131-K134. doi.org/10.1002/pssb.19670220259.
{56} M. Jiang, J. W. Zheng, H. Y. Xiao, Z. J. Liu, X. T. Zu, A comparative study of the mechanical and thermal properties of defective ZrC, TiC and SiC, Sci Rep. 7 (2017) 9344. doi.org/10.1038/s41598-017-09562-x.
{57} J. De Klerk, Elastic Constants and Debye Temperature of TiC Using a New Ultrasonic Coherent Pulse/cw Technique, Review of Scientific Instruments. 36 (1965) 1540-1545. doi.org/10.1063/1.1719387.
{58} C. Monachon, L. Weber, Effect of diamond surface orientation on the thermal boundary conductance between diamond and aluminum, Diamond and Related Materials. 39 (2013) 8-13. doi.org/10.1016/j.diamond.2013.06.017.
{59} C. Monachon, L. Weber, Thermal boundary conductance of transition metals on diamond, Emerging Materials Research. 1 (2012) 89-98. doi.org/10.1680/emr.11.00011.
{60} C. Monachon, L. Weber, Influence of diamond surface termination on thermal boundary conductance between Al and diamond, Journal of Applied Physics. 113 (2013) 183504. doi.org/10.1063/1.4804061.
{61} C. Kittel, Introduction to Solid State Physics, 8th ed., John Wiley & Sons, 2005.
{62} G. Chen, Nanoscale energy transport and conversion, Oxford University Press, New York, 2005.
{63} N. W. Ashcroft, N. D. Mermin, Solid state physics (saunders college, philadelphia, 1976), Google Scholar. (2010) 461.
{64} H. Li, Y. Chen, H. Wang, H. Wang, Y. Li, I. Harran, Y. Li, C. Guo, First-principles study of mechanical and thermodynamic properties of Ti—Ga intermetallic compounds, Journal of Alloys and Compounds. 700 (2017) 208-214. doi.org/10.1016/j.jallcom.2017.01.052.
{65} E. T. Swartz, R. O. Pohl, Thermal boundary resistance, Rev. Mod. Phys. 61 (1989) 605-668.
{66} C. Monachon, L. Weber, C. Dames, Thermal Boundary Conductance: A Materials Science Perspective, Annual Review of Materials Research. 46 (2016) 433-463. doi.org/10.1146/annurev-matsci-070115-031719.
{67} Z. Chen, Z. Wei, Y. Chen, C. Dames, Anisotropic Debye model for the thermal boundary conductance, Physical Review B. 87 (2013). doi.org/10.1103/PhysRevB.87.125426.
{68} J. C. Duda, P. E. Hopkins, J. L. Smoyer, M. L. Bauer, T. S. English, C. B. Saltonstall, P. M. Norris, On the assumption of detailed balance in prediction of diffusive transmission probability during interfacial transport, Nanoscale and Microscale Thermophysical Engineering. 14 (2010) 21-33.
{69} P. Reddy, K. Castelino, A. Majumdar, Diffuse mismatch model of thermal boundary conductance using exact phonon dispersion, Appl. Phys. Lett. 87 (2005) 211908. doi.org/10.1063/1.2133890.
{70} P. G. Klemens, R. K. Williams, Thermal conductivity of metals and alloys, International Metals Reviews. 31 (1986) 197-215. doi.org/10.1179/imtr.1986.31.1.197.
{71} D. P. H. Hasselman, L. F. Johnson, Effective Thermal Conductivity of Composites with Interfacial Thermal Barrier Resistance, Journal of Composite Materials. 21 (1987) 508-515. doi.org/10.1177/002199838702100602.
{72} E. Saiz, A. P. Tomsia, Atomic dynamics and Marangoni films during liquid-metal spreading, Nature Materials. 3 (2004) 903-909. doi.org/10.1038/nmat1252.
{73} N. Eustathopoulos, M. G. Nicholas, B. Drevet, Wettability at high temperatures, 1st ed, Pergamon, Amsterdam; New York, 1999.
{74} E. Saiz, A. P. Tomsia, R. M. Cannon, Ridging effects on wetting and spreading of liquids on solids, Acta Materialia. 46 (1998) 2349-2361. doi.org/10.1016/S1359-6454(98)80016-5.
{75} K. Landry, C. Rado, R. Voitovich, N. Eustathopoulos, MECHANISMS OF REACTIVE WETTING: THE QUESTION OF TRIPLE LINE CONFIGURATION, Acta Materialia. 45 (1997) 3079-3085. doi.org/10.1016/S1359-6454(96)00372-2.
{76} J. W. Mullin, Crystallization, Third Ed, Butterworth Heinemann, Oxford, 1997.
{77} S. A. Khairallah, A. Anderson, Mesoscopic simulation model of selective laser melting of stainless steel powder, Journal of Materials Processing Technology. 214 (2014) 2627-2636. doi.org/10.1016/j.jmatprotec.2014.06.001.
{78} S. A. Khairallah, A. T. Anderson, A. Rubenchik, W. E. King, Laser powder-bed fusion additive manufacturing: Physics of complex melt flow and formation mechanisms of pores, spatter, and denudation zones, Acta Materialia. 108 (2016) 36-45. doi.org/I0.1016/j.actamat.2016.02.014.
{79} T. W. Eagar, N. S. Tsai, Temperature Fields Produced by Traveling Distributed Heat Sources, Welding Journal. 62 (1983) 346-s-355-s.
{80} Materials Project, (n.d.). materialsproject.org/(accessed Jan. 10, 2021).
{81} H.-J. Kim, Y.-S. Ahn, Coating of chromium and titanium carbide on diamond particles in molten LiCl—KCl—NaCl, Journal of Alloys and Compounds. 849 (2020) 156508. doi.org/10.1016/j.jallcom.2020.156508.
{82} M. J. Assael, A. E. Kalyva, K. D. Antoniadis, R. Michael Banish, I. Egry, J. Wu, E. Kaschnitz, W. A. Wakeham, Reference Data for the Density and Viscosity of Liquid Copper and Liquid Tin, Journal of Physical and Chemical Reference Data. 39 (2010) 033105. doi.org/10.1063/1.3467496.
{83} Y. Nasersharifi, M. Kaviany, G. Hwang, Pool-boiling enhancement using multilevel modulated wick, Applied Thermal Engineering. 137 (2018) 268-276. doi.org/10.1016/j.applthermaleng.2018.03.073.
{84} O. N. Cora, D. Min, M. Kog, M. Kaviany, Microscale-modulated porous coatings: fabrication and pool-boiling heat transfer performance, J. Micromech. Microeng. 20 (2010) 035020. doi.org/10.1088/0960-1317/20/3/035020.
{85} D. H. Min, G. S. Hwang, Y. Usta, O. N. Cora, M. Koc, M. Kaviany, 2-D and 3-D modulated porous coatings for enhanced pool boiling, International Journal of Heat and Mass Transfer. 52 (2009) 2607-2613. doi.org/10.1016/j.ijheatmasstransfer.2008.12.018.
{86} S. G. Liter, M. Kaviany, Pool-boiling CHF enhancement by modulated porous-layer coating: theory and experiment, International Journal of Heat and Mass Transfer. 44 (2001) 4287-4311. doi.org/I0.1016/S0017-9310(01)00084-9.
{87} J.-F. Silvain, J.-M. Heintz, A. Veillere, L. Constantin, Y. F. Lu, A review of processing of Cu/C base plate composites for interfacial control and improved properties, Int. J. Extrem. Manuf. 2 (2020) 012002. doi.org/10.1088/2631-7990/ab61c5.
{88} Q. Fu, J. Yang, Y. Chen, D. Li, D. Xu, Experimental evidence of very long intrinsic phonon mean free path along the c-axis of graphite, Appl. Phys. Lett. 106 (2015) 031905. doi.org/10.1063/1.4906348.
{89} M. Tashiro, A. Kasahara, Method of bonding graphite to metal, U.S. Pat. No. 5,904,287A, 1999. patents.google.com/patent/U.S. Pat. No. 5,904,287/en (accessed Jun. 29, 2018).
{90} Aksoy, Doruk, Efe C. Balta, Dawn M. Tilbury, and Kira Barton. “A control-oriented model for bead cross-sectional geometry in fused deposition modeling.” In 2020 American Control Conference (ACC), pp. 474-480. IEEE, 2020.
{91} Balta, Efe C., Dawn M. Tilbury, and Kira Barton. “Layer-to-Layer Stability of Linear Layerwise Spatially Varying Systems: Applications in Fused Deposition Modeling.” IEEE Transactions on Control Systems Technology 29, no. 6 (2021): 2517-2532.
{92} Balta, Efe C., Ilya Kovalenko, Isaac A. Spiegel, Dawn M. Tilbury, and Kira Barton. “Model predictive control of priced timed automata encoded with first-order logic.” IEEE Transactions on Control Systems Technology 30, no. 1 (2021): 352-359.
{93} Balta, Efe. “Modeling and Intelligent Control for Spatial Processes and Spatially Distributed Systems.” PhD diss., 2021.
{94} Ben Alla, Hicham, Said Ben Alla, Abdellah Touhafi, and Abdellah Ezzati. “A novel task scheduling approach based on dynamic queues and hybrid meta-heuristic algorithms for cloud computing environment.” Cluster Computing 21, no. 4 (2018): 1797-1820.
{95} Fathizadan, Sepehr, Feng Ju, and Yan Lu. “Deep representation learning for process variation management in laser powder bed fusion.” Additive Manufacturing 42 (2021): 101961.
{96} Fathizadan, Sepehr, Feng Ju, Feifan Wang, Kyle Rowe, and Nils Hofmann. “Dynamic material deposition control for large-scale additive manufacturing.” IISE Transactions (2021): 1-15.
{97} Fathizadan, Sepehr, Feng Ju, Kyle Rowe, Alex Fiechter, and Nils Hofmann. “A novel real-time thermal analysis and layer time control framework for large-scale additive manufacturing.” Journal of Manufacturing Science and Engineering 143, no. 1 (2021).
{98} Fera, M., F. Fruggiero, A. Lambiase, R. Macchiaroli, and V. Todisco. “A modified genetic algorithm for time and cost optimization of an additive manufacturing single-machine scheduling.” International Journal of Industrial Engineering Computations 9, no. 4 (2018): 423-438.
{99} Guo, Shenghan, Mohit Agarwal, Clayton Cooper, Qi Tian, Robert X. Gao, Weihong Guo Grace, and Y. B. Guo. “Machine learning for metal additive manufacturing: Towards a physics-informed data-driven paradigm.” Journal of Manufacturing Systems 62 (2022): 145-163.
{100} Guo, Shenghan, Weihong “Grace Guo, and Linkan Bain. “Hierarchical spatial-temporal modeling and monitoring of melt pool evolution in laser-based additive manufacturing.” IISE Transactions 52, no. 9 (2020): 977-997.
{101} Hertlein, Nathan, Philip R. Buskohl, Andrew Gillman, Kumar Vemaganti, and Sam Anand. “Generative adversarial network for early-stage design flexibility in topology optimization for additive manufacturing.” Journal of Manufacturing Systems 59 (2021): 675-685.
{102} Huang, Jiwei, Chenxiang Zhang, and Jianbing Zhang. “A multi-queue approach of energy efficient task scheduling for sensor hubs.” Chinese Journal of Electronics 29, no. 2 (2020): 242-247.
{103} Joshi, Ameet V. “Linear Methods.” In Machine Learning and Artificial Intelligence, pp. 33-41. Springer, Cham, 2020.
{104} Lensgraf, Samuel, and Ramgopal R. Mettu. “Incorporating kinematic properties into fused deposition toolpath optimization.” In 2018 IEEE/RSJ International Conference on Intelligent Robots and Systems (IROS), pp. 8622-8627. IEEE, 2018.
{105} Oh, Yosep, Paul Witherell, Yan Lu, and Timothy Sprock. “Nesting and scheduling problems for additive manufacturing: a taxonomy and review.” Additive Manufacturing 36 (2020): 101492.
{106} towardsdatascience.com/schedule-optimisation-using-linear-programming-in-python-9b3e1bc241e1
{107} Udhayakumar, P., and S. Kumanan. “Integrated scheduling of flexible manufacturing system using evolutionary algorithms.” The International Journal of Advanced Manufacturing Technology 61, no. 5 (2012): 621-635.
{108} Wang, Feifan, Feng Ju, Kyle Rowe, and Nils Hofmann. “Real-time control for large scale additive manufacturing using thermal images.” In 2019 IEEE 15th International Conference on Automation Science and Engineering (CASE), pp. 36-41. IEEE, 2019.
{109} Wang, Feifan, Sepehr Fathizadan, Feng Ju, Kyle Rowe, and Nils Hofmann. “Print surface thermal modeling and layer time control for large-scale additive manufacturing.” IEEE Transactions on Automation Science and Engineering 18, no. 1 (2020): 244-254.
{110} www.altexsoft.com/blog/schedule-optimization/
{111} Yazdi, Reza Mojahed, Farhad Imani, and Hui Yang. “A hybrid deep learning model of process-build interactions in additive manufacturing.” Journal of Manufacturing Systems 57 (2020): 460-468.
{112} Berne, C.; Sluiter, M.; Pasturel, A. (2002). “Theoretical approach of phase selection in refractory metals and alloys”. Journal of Alloys and Compounds. 334: 27. doi:10.1016/S0925-8388(01)01773-X.)
{113} Nowotny phases (en.wikipedia.org/wiki/Nowotny_phase, Lu, Guoxin
{114} Cotton, F. Albert; Wilkinson, Geoffrey; Murillo, Carlos A.; Bochmann, Manfred (1999), Advanced Inorganic Chemistry (6th ed.), New York: Wiley-Interscience, ISBN 0-471-19957-5).
{115} en.wikipedia.org/wiki/Zintl_phase;
{116} Fassler, Thomas F. (2011). “Zintl Phases: Principles and Recent Developments”. 139. doi:10.1007/978-3-642-21150-8. ISSN 0081-5993;
{117} Fredrickson, Daniel C.; Lee, Stephen; Hoffmann, Roald; Lin, Jianhua (2004). “The Nowotny Chimney Ladder Phases: Following the Pseudo Clue Toward an Explanation of the 14 Electron Rule”. Inorganic Chemistry. 43 (20): 6151-6158. doi:10.1021/ic049427n. PMID 15446859;
{118} Fredrickson, Daniel C.; Lee, Stephen; Hoffmann, Roald (2004). “The Nowotny Chimney Ladder Phases: Whence the 14 Electron Rule?”. Inorganic Chemistry. 43 (20): 6159-6167. doi:10.1021/ic049897h. PMID 15446860.);
{119} Hume-Rothery, William. “The structure of metals and alloys.” Indian Journal of Physics 11 (1969): 74-74
{120} Jeitschko, Pearson, W. B. (1970). “Phases with Nowotny chimney-ladder structures considered as ‘electron’ phases”. Acta Crystallographica Section B. 26 (7): 1044-1046. doi:10.1107/S0567740870003564;
{121} Johnston, Roy L., and Roald Hoffmann. “Structure-Bonding Relationships in the Laves Phases.” Zeitschrift fdr anorganische und allgemeine Chemie 616, no. 10 (1992): 105-120.), Frank-Kasper phases (en.wikipedia.org/wiki/Frank-Kasper_phases
{122} Joubert, J. M.; Crivello, J. C. (2012). “Non-Stoichiometry and Calphad Modeling of Frank-Kasper Phases”. Applied Sciences. 2 (4): 669. doi:10.3390/app2030669
{123} Kauzlarich, S. M., Encyclopedia of Inorganic chemistry, 1994, John Wiley & Sons, ISBN 0-471-93620-0;
{124} King, R. Bruce (2007). “The Relationship between the Nowotny Chimney Ladder”. Revista de Chimie. 58 (5): 439-441;
{125} Lee, Stephen; Lin, Jianhua; You, Liping; Sun, Junliang; Schmidt, Joshua Teal (2002). “RuGavSnw Nowotny Chimney Ladder Phases and the 14-Electron Rule”. Journal of Solid State Chemistry. 164 (2): 210-219. doi:10.1006/jssc.2001.9462;
{126} Massalski, Tadeusz Bronislav, and Uichirb Mizutani. “Electronic structure of Hume-Rothery phases.” Progress in Materials Science 22, no. 3-4 (1978): 151-262
{127} Mizutani, Uichiro. “The Hume-Rothery rules for structurally complex alloy phases.” In Surface Properties And Engineering Of Complex Intermetallics, pp. 323-399, 2010
{128} Paxton, A. T., M. Methfessel, and D. G. Pettifor. “A bandstructure view of the Hume-Rothery electron phases.” Proceedings of the Royal Society of London. Series A: Mathematical, Physical and Engineering Sciences 453, no. 1962 (1997): 1493-1514.) compounds
{129} Sevov, S. C., Zintl Phases in Intermetallic Compounds, Principles and Practice: Progress, Westbrook, J. H.; Freisher, R. L.: Eds.; John Wiley & Sons. Ltd., Chichester, England, 2002, pp. 113-132 (Slavi Chapter);
{130} Stein, Frank, Martin Palm, and Gerhard Sauthoff. “Structure and stability of Laves phases. Part I. Critical assessment of factors controlling Laves phase stability.” Intermetallics 12, no. 7-9 (2004): 713-720
{131} Stein, Frank, Martin Palm, and Gerhard Sauthoff. “Structure and stability of Laves phases part II—structure type variations in binary and ternary systems.” Intermetallics 13, no. 10 (2005): 1056-1074

What is claimed is:

1. A powder material for additively manufacturing a structure, comprising:
metal particles; and
non-metallic particles with thermal conductivities greater than 100 W/m-K and coefficient of thermal expansion less than 10 ppm/degree C.,
wherein the metal particles are fusible with heat to form a heterogeneous solid structure around the non-metallic particles with an intermetallic compound interface, the heterogeneous solid structure having enhanced thermal conductivity and lower coefficient of thermal expansion with respect to a homogeneous specimen of the fused metal particles alone.

2. The powder material according to claim 1, wherein the metal particles and non-metallic particles are adapted to form the intermetallic compound interface in situ on a surface of the non-metallic particles at a fusion temperature of the metal particles.

3. The powder material according to claim 1, wherein the non-metallic particles comprise diamond particles, and the intermetallic compound interface is formed in situ as a metal carbide on a surface of the diamond particles during a fusion of the metal particles to form the heterogeneous solid structure.

4. The powder material according to claim 3, wherein the metal particles comprise metal alloy particles comprising at least 50% of at least one of copper and silver, and an amount between 0.1% and 10% by weight of at least one of Ti, Zr, V, Nb, Hf, Ta, Mo, Cr, and W, effective to form a metal carbide in situ in a surface of the diamond particles during a processing of the powder material at a fusion temperature of the metal particles.

5. The powder material according to claim 1, wherein the non-metallic particles are coated with the intermetallic compound interface prior to fusion of the metal particles to form the heterogeneous solid structure.

6. The powder material according to claim 1, wherein the non-metallic particles comprise metal carbide coated diamond particles.

7. A method for fabrication metal structures, comprising:
receiving a substrate;
depositing a powder on a surface of the substrate, the powder comprising metal particles and non-metallic particles with thermal conductivities greater than 100 W/m-K and coefficient of thermal expansion less than 10 ppm/degree C.;
heating the deposited powder to a fusion or sintering temperature of the metal particles with an energy source, to fuse or sinter the powder; and
cooling the fused or sintered powder to form a heterogeneous solid, wherein the non-metallic particles are in situ or ex situ coated with an intermetallic compound and dispersed in the heterogeneous solid.

8. The method according to claim 7, wherein the substrate comprises a packaged semiconductor, and the cooled fused or sintered powder is configured as a thermal dissipation structure.

9. The method according to claim 7, wherein the substrate comprises a semiconductor, and the metal particles react with the semiconductor at the fusion or sintering temperature to form an interfacial intermetallic composition.

10. The method according to claim 7, wherein the nonmetallic particles comprise diamond particles, which are thin film coated with at least one of Ti, Zr, V, Nb, Hf, Ta, Mo, Cr, and W.

11. The method according to claim 7, wherein the metal particles comprise at least one of copper and silver alloyed with between 0.01% and 10% of at least one of Ti, Zr, V, Nb, Hf, Ta, Mo, Cr, and W.

12. The method according to claim 7, wherein the substrate comprises at least one of silicon, a silicide, silica, gallium arsenide, gallium nitride, boron nitride, and a ceramic.

13. The method according to claim 7, wherein the substrate comprises an optical communication medium.

14. The method according to claim 7, wherein the substrate comprises a surface layer having a different composition than a bulk of the substrate, the surface layer adhering having greater adhesion to the substrate and to the heterogeneous solid than an adhesion of the substrate to the heterogeneous solid.

15. The method according to claim 7, wherein the nonmetallic particles comprise diamond particles coated with a magnetic cobalt layer.

16. The method according to claim 7, wherein the metal powder is selected from the group consisting of aluminum, titanium, steel, silver and copper, and alloys thereof.

17. The method according to claim 7, wherein the nonmetallic particles are pretreated to form a metal carbide surface layer comprising at least one of titanium carbide, chromium carbide, zirconium carbide, and tungsten carbide before the heating.

18. The method according to claim 7, further comprising treating of the nonmetallic particles with at least one of a salt bath process, a nanodeposition process, and a sputtering process to form a surface layer of the intermetallic compound before the heating.

19. The method according to claim 7, wherein the heating is selected from the group consisting of powder bed selective laser fusion, directed energy deposition, electron beam melting, and welding.

20. A heatsink, formed of a heterogeneous material comprising:
a metal matrix comprising at least one of copper and silver in an amount of at least 50% by weight; and
nonmetallic particles having an intermetallic compound carbide interlayer forming heterogeneous inclusions in the metal matrix,
wherein the heterogeneous material has a net thermal transfer coefficient of at least 430 W/m-K.
